(19) United States
(12) Patent Application Publication
(10) Pub. No.: US 2025/0146819 A1
(43) Pub. Date: May 8, 2025

(54) SILICON-BASED PIEZOELECTRIC INERTIAL SENSOR UNIT

(71) Applicant: TechnoSensors Inc., Sunny Isles, FL (US)

(72) Inventors: Gaston Dubé, Sainte-Anne-des-Monts (CA); Alfredo Rivière, Sunny Isles, FL (US)

(21) Appl. No.: 18/501,675

(22) Filed: Nov. 3, 2023

(51) Int. Cl. G01C 19/5712; G01P 15/09; H02N 2/18

(52) U.S. Cl. CPC G01C 19/5712; G01P 15/09; H02N 2/186

(57) ABSTRACT

A planar inertial measurement sensor unit (IMU) is disclosed. The IMU includes an E-shape structure using piezoelectric resonators to measure the Coriolis effect during rotation and inertial force during linear acceleration. The IMU may be microfabricated using thin films on silicon technology, which may be vacuum packed in less than 4 mm³ at wafer-level chip-scale using double eutectic seals and which may integrate vibration energy harvesting technology.

### FIELD OF THE INVENTION

The present application relates generally to an inertial sensor unit, and more particularly to a silicon-based piezoelectric inertial sensor unit.

### BACKGROUND OF THE INVENTION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

On the market, inertial measurement units (IMU) are sensors used to monitor physical displacements of a moving corpus without GPS or geo-positioning, external reference points or radars. Such instruments are a technical mimicry of living creatures' inherent ability to constantly self-assess their members' spatial position.

IMU sensors may be used in a variety of applications, such as in any one, any combination or all of applications: navigation; robotics; automotive; military; or customer electronics (e.g., portable smartphones, gaming or sporting devices) including intelligent headpieces or lenses for spatial computing or pointing. In some cases, the inertial measurement data may be analyzed in conjunction with information from other sensors such as image, pressure, altitude, magnetic sensors, etc. An example IMU sensor is disclosed in US Patent Application Publication No. 2010/0037692 A1, incorporated by reference herein in its entirety.

### SUMMARY

In one or some embodiments, a micro-structured inertial measurement sensor (IMS) is disclosed. The IMS includes: a peripheral frame; one or more mechanical elements supported at least partly by the peripheral frame, wherein the one or more mechanical elements are planar in structure, at least partly piezoelectric, and configured to generate movement indicative of rate of rotation and of acceleration; and one or more sensing elements configured to generate a plurality of signals indicative of the rate of rotation and of the acceleration.

### BRIEF DESCRIPTION OF THE DRAWINGS

The present application is further described in the detailed description which follows, in reference to the noted plurality of drawings by way of non-limiting examples of exemplary implementations, in which like reference numerals represent similar parts throughout the several views of the drawings. In this regard, the appended drawings illustrate only exemplary implementations and are therefore not to be considered limiting of scope, for the disclosure may admit to other equally effective embodiments and applications.

FIG. 1A is an example block diagram of an IMU sensor system.

FIG. 1B is an example block diagram of the IMU sensor system and an electronic device in communication with the IMU sensor system.

FIG. 1C is an example block diagram of IMU sensor communication system with a relay antenna.

FIG. 2 is an isometric view of the sensor element, in a planar arrangement.

FIG. 3A is an exploded view of a preferred wafer-level chip scale package in a planar arrangement.

FIG. 3B is an exploded view of a preferred and more compact wafer-level chip scale package in a multi-level arrangement.

FIG. 4A is a schematic view of the Coriolis detection principle in a CVG gyroscope.

FIG. 4B is a schematic view of a push-pull accelerometer along a sensitive axis.

FIG. 5 is a schematic representation of the piezoelectric effect.

FIG. 6A is a schematic expression of the d31 piezoelectric mode.

FIG. 6B is a schematic expression of the d33 piezoelectric mode.

FIG. 6C is an example illustration of various interdigitated electrodes configurations.

FIG. 7A illustrates a bottom view of the IMU.

FIG. 7B illustrates a top view of the IMU.

FIG. 8A illustrates the top cover (bottom view) of the IMU.

FIG. 8B illustrates the piezoelectric energy harvester (bottom view) of the IMU.

FIG. 8C illustrates the bottom cover (top view) of the IMU.

FIG. 9 indicates the material composition of the present invention.

FIG. 10 is a schematic view of the manufacturing process.

FIG. 11A illustrates an example of a double-E monolithic gyroscope-accelerometer.

FIG. 11B illustrates additional details of the double-E monolithic gyroscope-accelerometer illustrated in FIG. 11A.

FIGS. 12A-B illustrate the general operation of the double-E gyroscope structure.

FIG. 13A is an illustration of the Coriolis effect about the X or Y axis (side view).

FIG. 13B is an illustration of the Coriolis effect about the Z axis (top view).

FIG. 14 is a graph of the Gyroscope sensitivity, as V per rate of rotation (°/s).

FIGS. 15A-B are illustrations of the Z-axis displacement on the push-pull accelerometer.

FIG. 16 is an illustration of the X- or Y-axis displacement on the push-pull accelerometer.

FIG. 17 is a graph illustrating the accelerometer sensitivity, as Vf/G-Frequency shift per G accel.

FIG. 18 is an illustration of the piezoelectric energy harvester in motion.

FIG. 19 is a graph illustrating the power (W) extracted via the PEH function under certain vibration patterns, under an acceleration (g) and a frequency (Hz).

FIG. 20 is a block diagram of one example of IMU sensor system at the pin level.

FIGS. 21A-C are illustrations of the gyroscope with in-plane resonators.

FIGS. 22A-D are illustrations of the gyroscope with out-of-plane Coriolis vibrations (e.g., rotations around the X/Y axes).

FIGS. 23A-B are illustrations of the gyroscope with in-plane Coriolis vibrations (e.g., rotation around the Z axis).

FIGS. 24A-C are illustrations of the accelerometer indicative of acceleration along the Y axis.

FIGS. 25A-D are illustrations of the accelerometer illustrating output-of-plane resonators.

FIG. 26 is a general computer system, programmable to be a specific computer system, which may represent any of the computing devices referenced herein.

### DETAILED DESCRIPTION OF THE INVENTION

The methods, devices, systems, and other features discussed below may be embodied in a number of different forms. Not all of the depicted components may be required, however, and some implementations may include additional, different, or fewer components from those expressly described in this disclosure. Variations in the arrangement and type of the components may be made without departing from the spirit or scope of the claims as set forth herein. Further, variations in the processes described, including the addition, deletion, or rearranging and order of logical operations, may be made without departing from the spirit or scope of the claims as set forth herein.

It is to be understood that the present disclosure is not limited to particular devices or methods, which may, of course, vary. It is also to be understood that the terminology used herein is for the purpose of describing particular embodiments only and is not intended to be limiting. As used herein, the singular forms “a,” “an,” and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.” The term “coupled” means directly or indirectly connected. The word “exemplary” is used herein to mean “serving as an example, instance, or illustration.” Any aspect described herein as “exemplary” is not necessarily to be construed as preferred or advantageous over other aspects. The term “uniform” means substantially equal for each sub-element, within about ±10% variation.

As used herein, “obtaining” data generally refers to any method or combination of methods of acquiring, collecting, or accessing data, including, for example, directly measuring or sensing a physical property, receiving transmitted data, selecting data from a group of physical sensors, identifying data in a data record, and retrieving data from one or more data libraries.

As used herein, terms such as “continual” and “continuous” generally refer to processes which occur repeatedly over time independent of an external trigger to instigate subsequent repetitions. In some instances, continual processes may repeat in real time, having minimal periods of inactivity between repetitions. In some instances, periods of inactivity may be inherent in the continual process.

If there is any conflict in the usages of a word or term in this specification and one or more patent or other documents that may be incorporated herein by reference, the definitions that are consistent with this specification should be adopted for the purposes of understanding this disclosure.

As discussed in the background, IMU sensors may be used in a variety of applications. As one example, IMU sensors may technically mimic a self-assessment of spatial position, which may be used as part of self-consciousness and thus may be an important component of future systems based on artificial intelligence AI. As another example, IMU sensors may be used as a central component of any AI-based moving equipment if their performances satisfy the stringent requirements in term of dimensions, energy consumption and precision.

Another application of IMU sensors may comprise recognition of activities of daily living (ADL) based on AI such as gait or fall monitoring for elderlies or post-surgery surveillance is emerging. Beyond surveillance, the usage of ADLs may be extended to sports training or finer gesture monitoring. As one example, IMU sensors may be used for monitoring at least one aspect of a respective player's body (e.g., IMU generates data indicative of acceleration and/or rotation for analysis for concussion monitoring). As another example, IMU sensors may be used to monitor at least one aspect of the respective player's performance (e.g., IMU generates data for analysis of the speed or agility of the respective player). Such ADL devices may either use gyroscopes and accelerometers or IMU; however, the overall dimensions of these wearable devices and battery duration remain an issue. Prior art wearable watches address the battery duration issue with vibration harvesting technology, thereby permitting battery recharge from human motions. Though, the size of such recharging technologies is a limiting factor for microelectronic applications. Generally speaking, piezoelectric-based vibration energy harvesting technology may be among the highest energy density available, which may be defined as mWh/mm³.

For some or all of these listed markets, there is a need for such a microsensor configured to precisely sense movement over a plurality of axes (such as 3 axes) of rotation and a plurality of axes (such as 3 axes) of acceleration in a microchip element (such as a single microchip element) in a compact volume not greater than 20 mm³ (e.g., not greater than 15 mm³; not greater than 5 mm³; not greater than 5 mm³; etc.). In one or some embodiments, the IMU may be wafer-level chip scale packaged (WLCSP) under a vacuum having a reduced or minimal height and footprint with reduced or minimal energy demand with less than 1 mW (e.g., less than 500 μW, less than 400 μW less than 300 μW less than 200 μW; less than 100 μW). Hence, since most of these sensors are utilized in a dynamic environment, an integrated motion and vibration energy harvesting technology may be embedded within the same package, and in turn, may be beneficial to decrease external energy needs (e.g., the generate energy so that a local power source is not needed at all or a smaller power source may power the IMU). Thus, in one or some embodiments, an integrated IMU is disclosed that is configured to include one, some, or all of the features listed above.

Separately, precise and sensitive angular rate sensors or accelerometers typically are either effective on a single XY plane only, or are larger than 100 mm³ (e.g., larger than 200 mm³) or consume greater than 0.1 W (e.g., greater than 1 W, greater than 5 W, greater than 7 W, or as much as 10 W) of electric power to operate. Most of the angular rate sensors or accelerometers on a single chip are either not precise due to the detection principle used or are sensible over one or two axes of rotation only and the integration of a plurality of such sensors on a board would require more physical space compared to a single chip solution. Separate from this, IMU sensors typically lack energy harvesting technology.

Typical inertial sensors are made of solid-state class-32 crystals that are difficult to manufacture, cannot be used efficiently to produce MEMS components small enough to enable a high level of integration with other electronic components, and cannot be vacuum-sealed at wafer level to decrease the size and cost of packaging. In this regard, a crystal-based solution is exceedingly limited.

Thus, in one or some embodiments, an IMU is disclosed based on one or both of: (i) vibrating piezoelectric microstructures; or (ii) with energy harvesting capabilities, which may, in one or some embodiments, be in wafer-level chip scale packaging under vacuum.

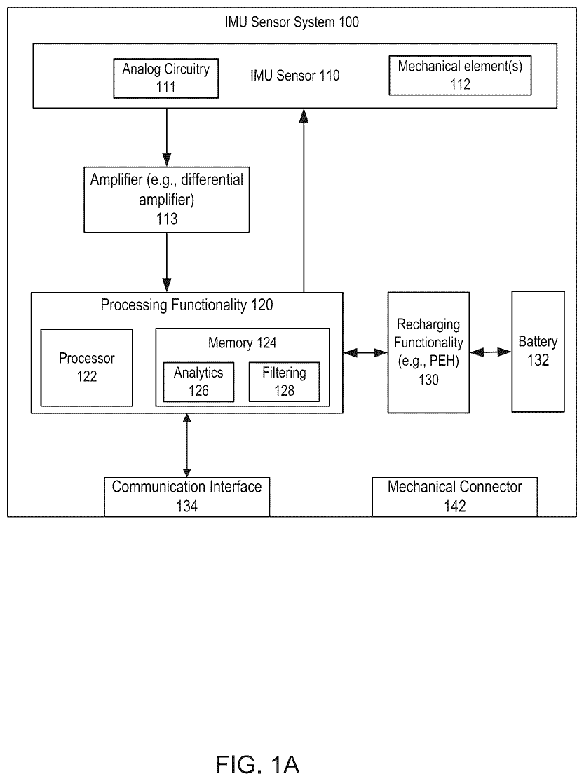

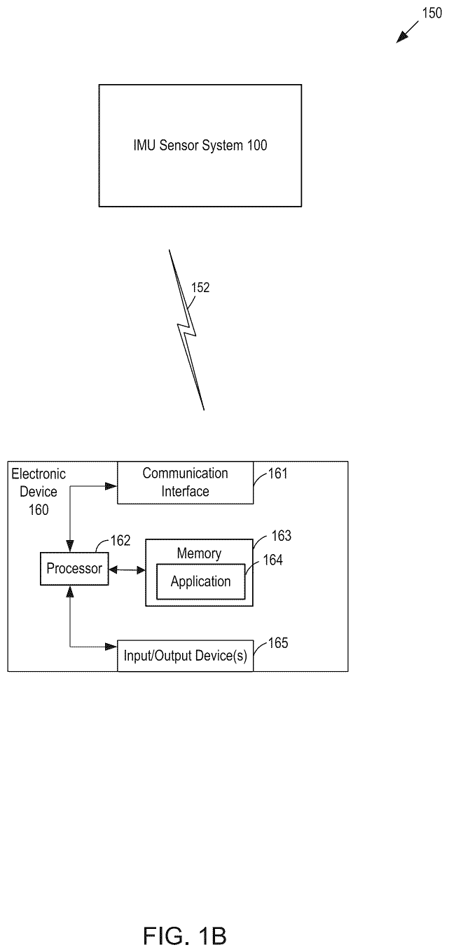

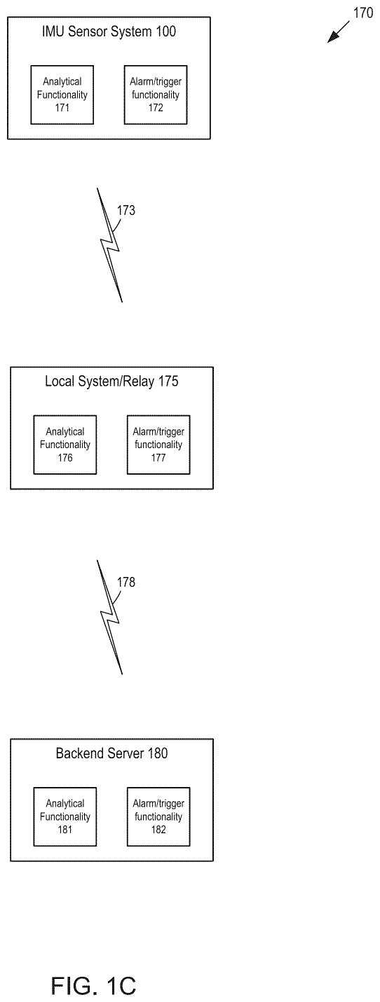

Referring to the figures, FIG. 1A is an example block diagram of an IMU sensor system 100. The IMU sensor system may include any one, any combination, or all of: an IMU sensor 110; amplifier functionality (e.g., amplifier 113); processing functionality 120; recharging functionality 130; one or more communication interfaces (such as communication interface 134); or one or more mechanical connectors (such as mechanical connector 136).

The IMU sensor 110 may include one or more mechanical elements 112 and analog circuitry 111. In one or some embodiments, the one or more mechanical elements 112 are any one, any combination, or all of: supported at least partly by the peripheral frame; planar in structure; at least partly piezoelectric; or configured to generate movement indicative of rate of rotation and/or of acceleration. Further, the analog circuitry 111 is an example of sensing element(s) configured to: sense the movement indicative of the rate of rotation and/or of acceleration; and generate one or more signals, such as a plurality of signals, indicative of the rate of rotation and/or of the acceleration, as discussed further in detail below. For example, the analog circuitry 111 may be configured to perform one or both of: generate an analog electric signal that is proportional to the amplitude of the frequency of one or more of the plurality of signals (and thus is indicative of the rate of rotation and may be used by the processing functionality 120 to determine the rate of rotation); and generate an analog electric signal that is proportional to the frequency shift of other of the plurality of signals (and thus is indicative of the acceleration and may be used by the processing functionality 120 to determine the acceleration).

In one or some embodiments, amplifier 113 may be used to amplify the signal(s) generated by the analog circuitry 111 of the IMU sensor 110 prior to receipt by processing functionality 120. Alternatively, in certain instances, amplifier 113 is unnecessary depending on the logic within processing functionality 120.

Processing functionality 120 may include one or more processors (such as processor 122) and one or more memories (such as memory 124). In one or some embodiments, processor 122 may comprise a microprocessor, controller, PLA, or the like. Memory 124 may comprise any type of storage device (e.g., any type of memory) and may store information (such as sensor data, discussed further below) and/or software. As shown in FIG. 1A, memory 124 may include one or more functions stored therein, such as analytics 126 and/or filtering 128. Processor 122 may be configured to execute the software stored in the memory, such as software for analytics (resident in analytics 126) and/or software for filtering (resident in filtering 128), in order to perform the various functions, such as analytics and filtering, discussed in further detail below. Though processor 122 and memory 124 are depicted as separate elements, they may be part of a single machine, which includes a microprocessor (or other type of controller) and a memory. Alternatively, processor 122 may rely on memory 124 for all of its memory needs.

Thus, in one or some embodiments, IMU sensor 110 may generate sensor data that is transmitted to processor 122. Processor 122 may perform one or more actions, such as any one, any combination, or all of: modifying the sensor data; altering the sensor data; adding to the sensor data; analyzing the sensor data; etc. As one example, processor 122 may modify the sensor data using filtering (from filtering 128). As another example, processor 122 may add to the data by including data associated with the sensor data, such as a time stamp data, indicative of a time at (or nearly at) which the sensor data was generated by IMU sensor 110. The time stamp data may be generated by a timer resident on processor 122, and may be associated with the underlying sensor data (such as stored along with, tagged along with, or the like).

Processor 122 and memory 124 are merely one example of a computational configuration. Other types of computational configurations are contemplated. For example, all or parts of the implementations may be circuitry that includes a type of controller, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

Referring back to FIG. 1A, IMU sensor system 100 further includes recharging functionality 130, such as piezoelectric energy harvester (PEH), discussed further below, which may be configured to recharge battery (or batteries) 132. Alternatively, or in addition, IMU sensor system 100 may include a battery charge interface in which a power may be input in order to recharge battery 132. IMU sensor system 100 may further communicate with an external electronic device, such as via communication interface 134. Communication interface may comprise a wired and/or a wireless communication interface in order to communicate with the external electronic device via wire or wirelessly, as discussed further below. Moreover, IMU sensor system 100 may include mechanical connector 136, which may be configured to mechanically or physically connect to another device. In one or some embodiments, mechanical connector may include (or have thereon) an adhesive in order to adhere to another surface or metallic connection pads. In one or some embodiments, IMU sensor system 100 may include a reduced power mode. By way of example, responsive to the processing functionality 120 determining that no movement (or movement less than a predetermined threshold) has detected for at least a predetermined amount of time, a sleep mode may be triggered to decrease the energy consumption.

FIG. 1B is an example block diagram 150 of the IMU sensor system 100 and an electronic device 160 in communication with the IMU sensor system 100. Various electronic devices are contemplated such as control modules, relay antennas, inertial data loggers, etc. Specifically, FIG. 1B illustrates that electronic device 160 includes a processor 162, a memory 163 configured to store the instructions for operating an application 164 such as inertial data filtering or sampling, power control, etc., input/output device(s) 165 (e.g., displays, touchscreens, etc.), and a communication interface 161. In one or some embodiments, communication interface 161 may a wireless communication interface configured to communicate wirelessly 152 with IMU sensor system 100.

Specifically, in one or some embodiments, the IMU sensor system 100 may be customized to serve as inertial data measurement for athletes in sporting activities. In this regard, the IMU sensor system 100 may be worn, attached to, or associated with the body of the athlete (e.g., in the shoes of the athlete) in order to generate data as the athlete moves. For example, the IMU sensor system may be used as part of or integrated with a helmet, or other type of individual protection, for movement monitoring of the respective athlete.

In one or some embodiments, the movement monitoring may be continuous movement monitoring (e.g., generating and/or transmitting data at predetermined intervals) that may permit detailed positioning or motion analysis (e.g., including analysis of the rate of rotation of the neck near the cervical). Alternatively, any one, any combination, or all of the movement monitoring, the data analysis, or the data transmission may be dependent on predetermined triggering events occurring. For example, in monitoring an athlete for potential concussions, certain triggering events, such as the acceleration exceeding a predetermined acceleration threshold and or the rotation exceeding a rotation threshold, may in turn trigger one or more actions, such as one or both of data analysis and/or data transmission, as discussed in more detail in FIG. 1C.

For example, FIG. 1C is another example block diagram 170 of the IMU sensor system 100 integrated with one or more electronic devices, such as local system/relay 175 and backend server 180. One, some or each of IMU sensor system 100, local system/relay 175 and backend server 180 may include analytical functionality 171, 176, 181 and/or alarm/trigger functionality 172, 177, 182. In practice, one or more actions may be performed responsive to a determination that the respective moving corpse is accelerated and/or rotated beyond a predetermined threshold. In one or some embodiments, the determination as to whether the trigger has occurred (e.g., the acceleration exceeding a predetermined acceleration threshold and or the rotation exceeding a rotation threshold) may be performed at the IMU sensor system 100 using the analytical functionality 171. In turn, the IMU sensor system 100 may use alarm/trigger functionality 172 to notify one or both of local system/relay 175 and backend server 180. In such an example, the IMU sensor system 100 may use alarm/trigger functionality 172 to transmit via wireless communication 173 of any one, any combination, or all of: inertial data; acceleration data; speed data; direction data; etc. The transmitted data may further be time-stamped.

Alternatively, the IMU sensor system 100 may continuously transmit data (e.g., indicative of one or both of acceleration or rotation) to one or both of local system/relay 175 and backend server 180. In turn, one or both of local system/relay 175 and backend server 180 may use its respective analytical functionality 176, 181 to analyze the data and, responsive to identifying a trigger, use alarm/trigger functionality 177, 182 (e.g., local system/relay 175 may transmit the data and/or analysis wirelessly 178 to backend server 180). In this way, the data, which may comprise relevant rotation and acceleration data, may be analyzed in real-time (either locally at the player or locally at the local system/relay 175 and/or remotely at the backend server 180). In addition, the notification as to the results of the analysis may likewise be performed in real-time, such as locally (e.g., at the local system/relay 175 and/or at the IMU sensor system 100). The notification may be manifested in one of several way. In one way, the notification at the local system/relay 175 may comprise generating an output on a graphical user interface (GUI), such as on a screen of the local system/relay 175. In another way, the notification at the IMU sensor system 100 may comprise an aural output and/or a visual output (e.g., a flashing LED) and/or a tactile output (e.g., a buzzing).

Thus, in one or some embodiments, responsive to a predetermined trigger (e.g., an acceleration greater than a predetermined amount), data may be transmitted (e.g., locally and/or remotely) from the IMU sensor system 100. The data may comprise relevant rotation and acceleration data. In this regard, the processing functionality 120 may determine whether or when to transmit the data responsive to analysis of the sensor data generated by the IMU sensor 110. Alternatively, or in addition, the IMU sensor system 100 may periodically transmit the data (e.g., every 10 seconds).

Alternatively, the IMU sensor system 100 may be used to provide inertial information of 3D spatial displacements to a control system, such as a control system of a robotic arm in surgery or other fine motor usages that requires motion control from a remote location. For example, in one or some embodiments, the IMU sensor system 100 may be used to generate data (such as inertial data) which may be continuously generated. In this way, the IMU sensor system 100 (which is very small in its packaging, as discussed above) may assist in more precisely identifying the position of the robotic arm. Thus, using the precise position information, the robotic arm may navigate more precisely, such as navigate in various parts of the body to perform surgery and/or to guide equipment (e.g., medical equipment, diagnostic equipment, such as a camera, or the like).

As still another application, the IMU sensor system 100 may be used for automatic position correction (e.g., for various moving objects, such as vehicles, missiles, or the like). In this way, the IMU sensor system 100 may be used for guidance applications and may replace optical-fiber gyros (OFG) for advanced navigation usage using a format that is a fraction of the size of a typical OFG system. For example, in certain instances, GPS signals may not be available. In such cases, the IMU sensor system 100 may be used to correct the trajectory using feedback signals for direction and acceleration.

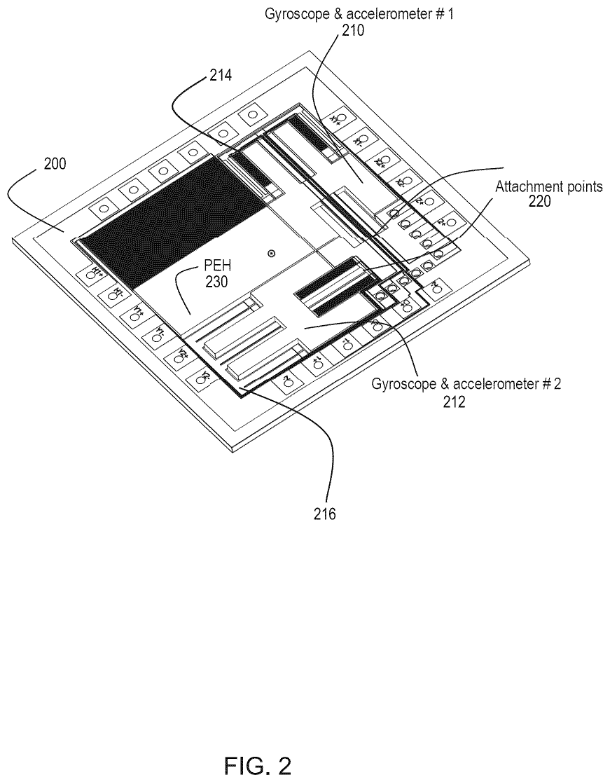

FIG. 2 illustrates an isometric view of the one embodiment of a sensor element 200, in a planar arrangement (e.g., planar in structure), that may include at least one, such as a plurality, of gyroscope & accelerometer structures. In particular, FIG. 2 illustrates a first gyroscope & accelerometer structure (see gyroscope & accelerometer #1 (210)) and a second gyroscope & accelerometer structure (see gyroscope & accelerometer #2 (212)). Various gyroscope & accelerometer structures are contemplated, such as an E-shaped structure or multiple arm-based structure.

In particular, FIG. 2 illustrates two planar E-shaped gyroscopes 214, 216 that are part of the orthogonal double monolithic gyroscope-accelerometer 210, 212 with a footprint of less than 10 mm², less than 9 mm², less than 8 mm², less than 7 mm², less than 6 mm², less than 5 mm², less than 4 mm², or less than 3 mm², and a piezoelectric energy harvester (PEH) 230. In this regard, FIG. 2 illustrates gyroscope and accelerometer structures that may have a double-E structure with a footprint of less than 3 mm². In one or some embodiments, the E-shaped structures 214, 216 may include a center arm and a plurality (such as two) side arms. These components may be attached to a support frame (interchangeably termed a peripheral frame) via cantilever points 220 from one end leaving the other end suspended and free to move.

In one or some embodiments, the structure, such as the E-shaped structure, may comprise a plurality of arms (such as suspension arms). The suspension arms are an example of a cantilevered structure. Tines, forks, hinges, or the like are contemplated as well. Further, in one or some embodiments, the arms may be built on the single layer. This is in contrast to other devices which may manufacture the arms and then install the arts on the single layer. In contrast, in one or some embodiments, the arms are machined on the single layer, thereby enabling the sensor (whether for the accelerometer and/or for gyroscope) to be built on the single layer.

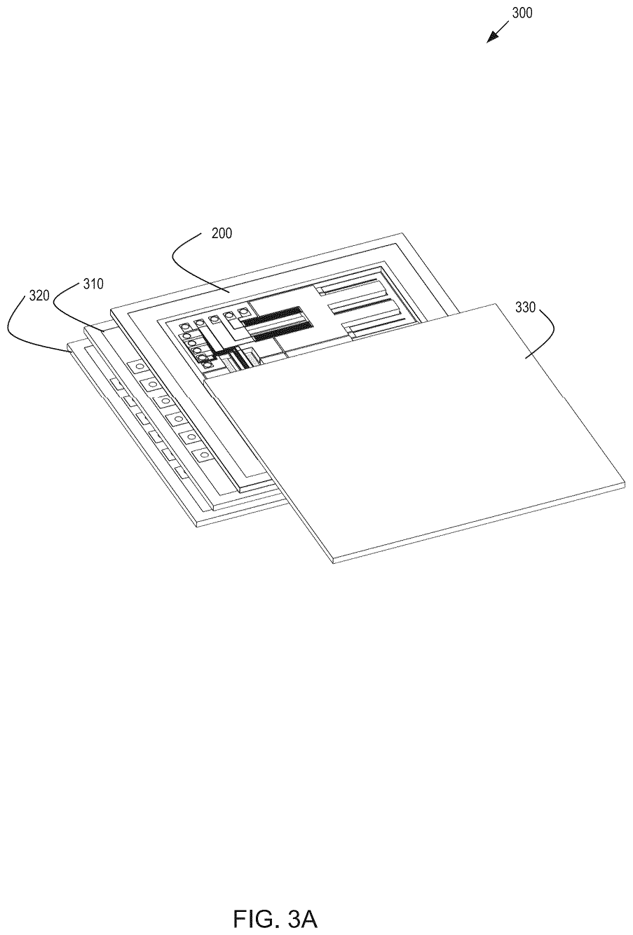

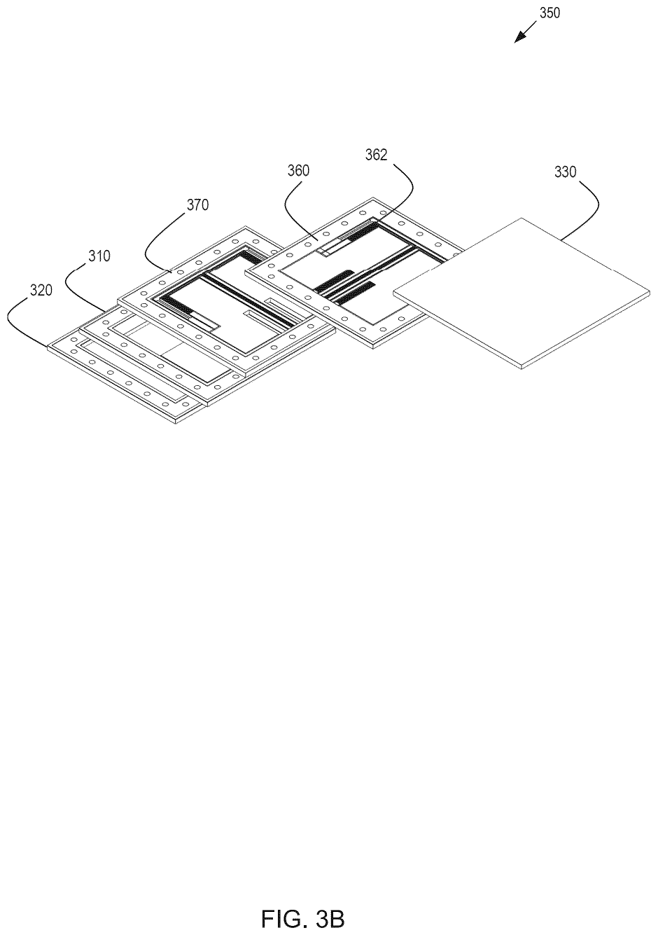

In one or some embodiments, sensor element 200 is enclosed in a very thin and compact package having less than 10 mm³, less than 9 mm³, less than 8 mm³, less than 7 mm³, less than 6 mm³, less than 5 mm³ or less than 4 mm³ with a thickness of less than 0.7 mm, less than 0.6 mm, less than 0.5 mm, less than 0.4 mm or less than 0.3 mm. Thus, in one or some embodiments, the sensor element 200 may be microfabricated using thin films on silicon technology which is vacuum packed in less than 4 mm³ at wafer-level chip-scale using double eutectic seals (e.g., vauum-sealed using two parallel and concurrent eutectic seals) and integrates a vibration energy harvesting technology. An example planar arrangement is illustration 300 in FIG. 3A, which may use an optional PEH (piezoelectric energy harvester) layer 310, a bottom cover with under bump connection 320 and a top cover 330. In one or some embodiments, this disclosed micro-packaging may be environmentally protected using double eutectic seals between any one, any combination, or all of components 200, 310, 320, 330. Further, in one or some embodiments, embedded active or passive electronic components, which may comprise any one, any combination, or all of resistors, capacitors, operational amplifiers or microcontroller may be integrated in packaged or die forms on one or more additional layers or directly in a cavity of one or both of the top cover 330 or the bottom cover. As shown in the illustration 350 in FIG. 3B, an even smaller micro-package having less than 6 mm³, less than 5 mm³, or less than 4 mm³ may be achieved when each independent and orthogonal double monolithic gyroscope-accelerometer 210, 212, which may comprise a monolithic orthogonal structure that includes one or more gyroscopes and one or more accelerometers that are manufactured in combination, is positioned in separate layers 360 (see E-shaped monolithic gyroscope-accelerometer 362 having the orientation of E structure 214), 370 (having the orientation of E-shaped structure 216) with an additional suspended mass and increased gyroscope sensitivity due to the larger structures than depicted in FIG. 2. In this regard, sensor element 200 may sense at least 3 axes of rotation sensitivity and/or at least 3 axes of acceleration in a thin package. This is unlike other IMU sensors, which may require one or two sensors for sensing rotation in the X-Y plane and an additional orthogonal sensor for sensing in the orthogonal plane (the Z-plane), thereby necessitating a cube-like container for the sensor.

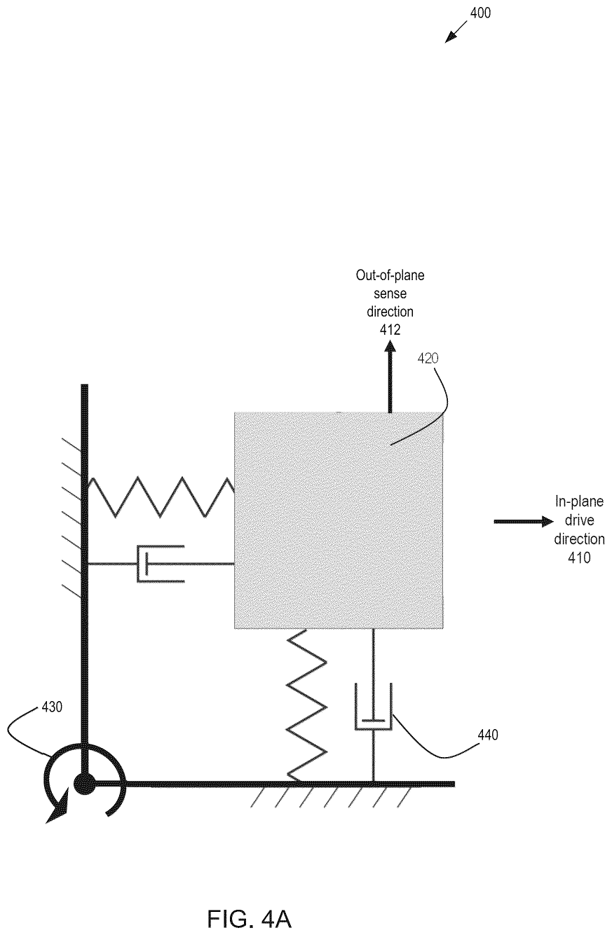

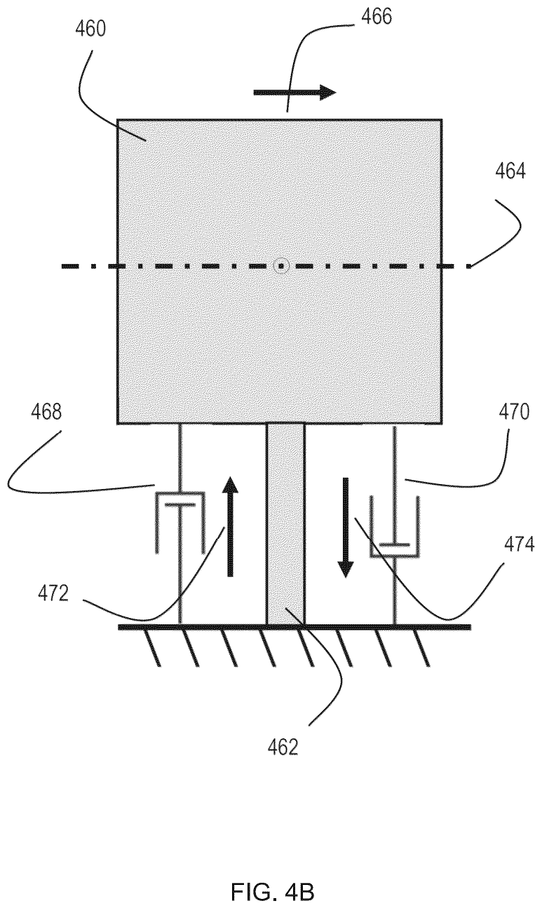

The sensor element 400 may use a three-axis Coriolis vibrating gyro (CVG) where a Coriolis effect is generated by a plurality of piezoelectric in-plane resonators (e.g., in-plane drive resonators). As shown in FIG. 4A, the in-plane oscillating direction 410 may be perpendicular to an out-of-plane Coriolis effect 412 being generated when such in-plane resonators 420 having a certain mass is rotated around an orthogonal axis at a rate or rotation 430. In such circumstances, it has been demonstrated that stress generated in detection member 440 of such configuration may be proportional (e.g., linear) to the rate of rotation 430. Thus, such stress measurement in detection member 440 may represent the CVG output.

Alternatively, or in addition, the sensor element 400 may use a plurality of orthogonal accelerometers, such as two orthogonal accelerometers, that are sensible over a plurality of orthogonal axes of acceleration, such as three orthogonal axes of acceleration. FIG. 4B is an illustration 450 of one example of the modus operandi of such an accelerometer. In one or some embodiments, a movable mass 460 may be suspended by a middle arm 462 in a such manner that only movements along axis 464 are possible. When the sensor having mass 460 is subjected to a force 466 caused by an acceleration, vibrating resonators 468 and 470, disposed at equidistance on each side of a middle arm 462, may be either longitudinally compressed or pulled in the direction indicated 472 and 474. In one or some embodiments, the vibrating resonant frequency of resonators subjected to such tension or compression may vary proportionally to longitudinal stress. The frequency difference between vibrating resonators 468 and 470 may then be proportional to force 466 and may represent the accelerometer output. In this regard, the piezoelectric material may be used to measure at least one aspect regarding frequency signal in order to generate sensor data for one or both of the accelerometer or the gyroscope. As one example, a change in the frequency of the frequency signal shift may be indicative of acceleration. As another example, a sensed amplitude change of the frequency signal (even though the frequency remains the same) may be used for the gyroscope measurement. This is in contrast to previous IMU sensors, which may have relied on capacitive measurements (which may be less precise) and/or which may have only measured one aspect of the frequency signal (e.g., only one of the amplitude of the frequency (for the gyroscope) or the frequency itself (for the accelerometer)).

### Piezoelectricity and Modes of Operation

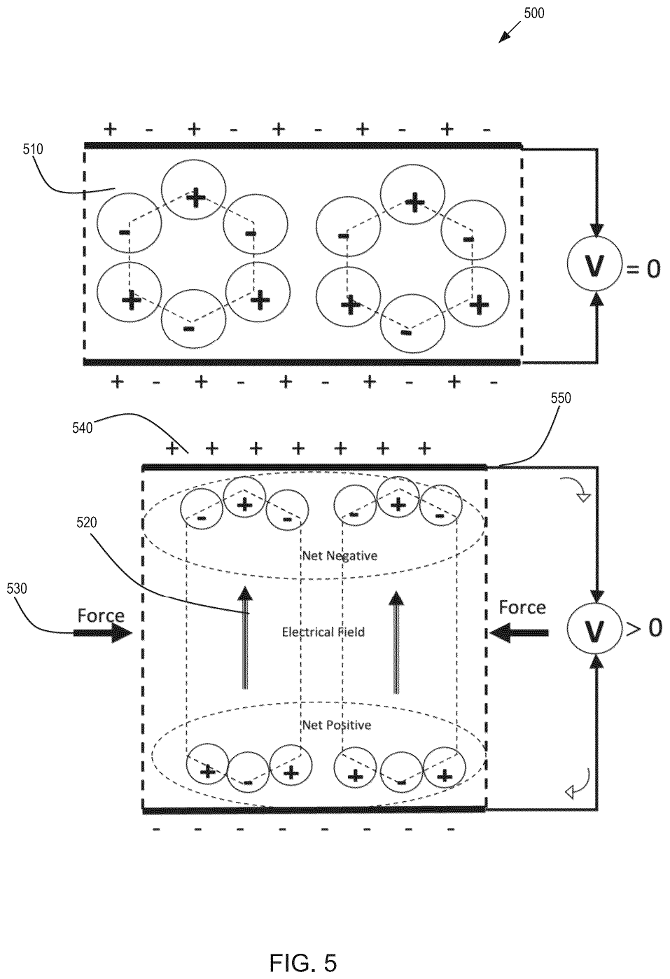

As shown in the illustration 500 in FIG. 5, a piezoelectric material 510 may create proportional surface electric charges 520 due to an internal electrical field 530 when mechanical stress 540 is applied to it. The accumulation of such electric charges may be collected by metallic electrodes 550 that may be disposed on its surface; thus, voltage may be measured. In this regard, piezoelectric material with the metallic electrodes 550 may comprise part or all of the sensing element(s). In one or some embodiments, the thickness of such metallic electrodes 550 may be: less than 10 microns; less than 9 microns; less than 8 microns; less than 7 microns; less than 6 microns; less than 5 microns; less than 4 microns; less than 3 microns; less than 2 microns; less than 1 micron; less than 0.9 microns; less than 0.8 microns; less than 0.7 microns; less than 0.6 microns; or less than 0.5 microns; etc. The resulting measurements may be proportional to the amount of stress applied. Inversely, the converse piezoelectrical effect may be the ability of such material to create proportional strains or deformations when such material is submitted to an electrical field. In one or some embodiments, both principles may together form the basis of operation of the disclosed sensor where charges may be generated by the direct piezoelectric effect when the Coriolis effect induces vibration while the converse piezoelectric effect may be used to drive the resonators with an external sinusoidal source of tension. Thus, in one or some embodiments, the sensor may use a semiconductor-based substrate, which includes a thin film for the piezoelectric layer that may be sputtered on one or both sides of one or more structures, such as the cantilevered structure(s), in order to more easily create the electric field. In one or some embodiments, the sputtering of the piezoelectric layer onto the cantilevered structure(s) may be selective, such as at certain portion of the cantilevered structure. Sputtering may comprise ejecting piezoelectric particles onto the surface of the semiconductor-based substrate after the piezoelectric particles is itself bombarded by energetic particles of a plasma or a gas. Sputtering is one example of applying a thin film of the piezoelectric layer. Other ways in which to apply microscopic particles onto the surface of the semiconductor-based substrate are contemplated. In one or some embodiments, in total, less than 20%, less than 15%, less than 10% or less than 5% of the surface of at least a part of the sensor (e.g., a respective arm) is covered with piezoelectric material.

Mathematically, direct and converse piezoelectricity may be described using a vectorial form of an elastic piezo material having an elastic compliance sᵢⱼ, a piezoelectric coefficient dᵢⱼ and an electric permittivity or polarizability εᵢⱼ. These coefficients may be relatives to an orthogonal strain axis i and an electrical field orientation j:

$${S}_{i j} = \sum {s}_{i j} \cdot T + \sum {d}_{i j} \cdot {E}_{i} \qquad ( 1 )$$

$${D}_{i} = \sum {d}_{i j} \cdot T + \sum {ε}_{i j} \cdot {E}_{i} \qquad ( 2 )$$

where T and E represent the mechanical stress and electrical field, respectively. It is noted that the strain Sᵢⱼ may be the direct piezoelectric effect while the electric displacement Dᵢ may be the converse piezoelectric effect. From equations (1) and (2), the orientation of the surface electrodes and electrical fields may be determinant factors in the selection of the desired mode of operation.

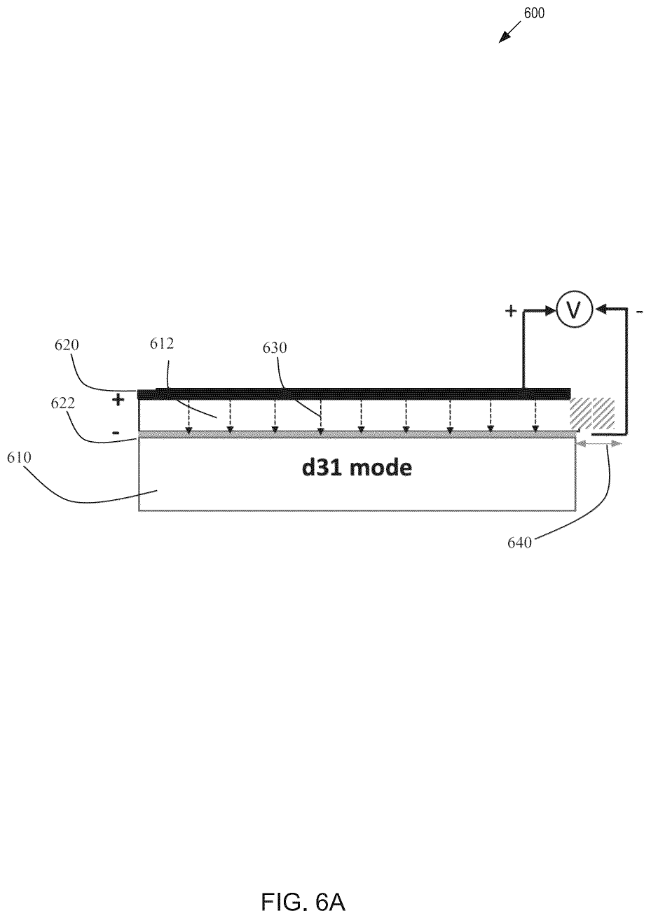

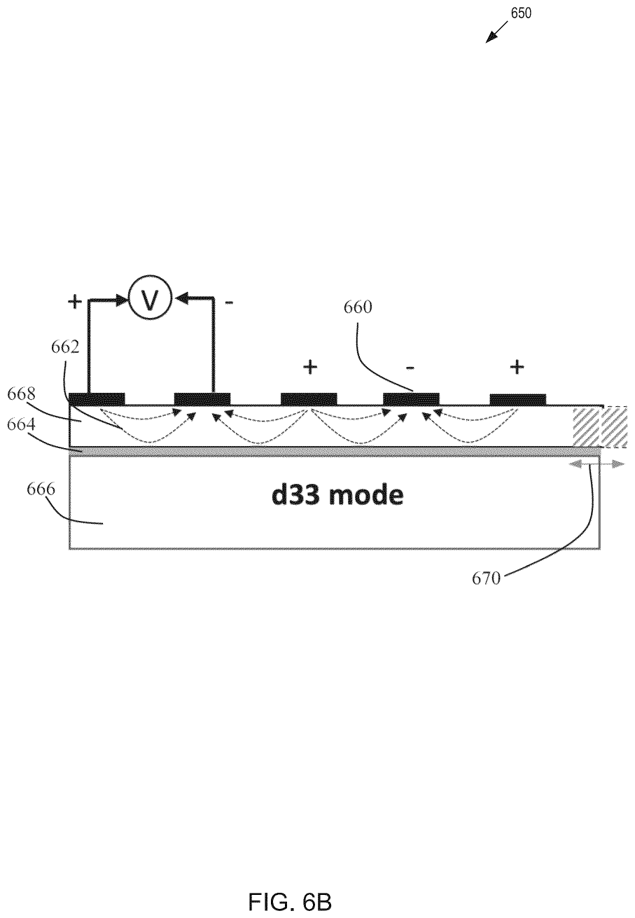

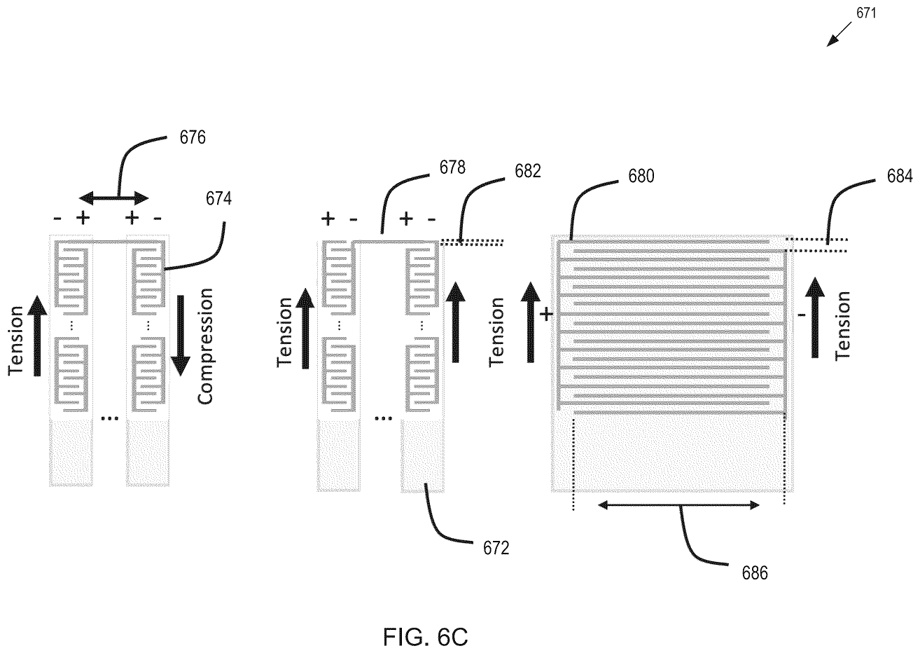

As shown in the illustration 600 of the schematic expression of the d₃₁ piezoelectric mode in FIG. 6A, substrate 610 may support a piezoelectric layer 612 having longitudinal electrodes 620, 622 that are patterned on the top and bottom of the piezoelectric layer 612 and may be connected to a source (V). This arrangement may generate, by converse electrical effect, an electric field 630 and, consequently, the piezoelectric layer will have a strain 640 that may be perpendicular to the orientation of the electric field. Such a d₃₁ mode of operation may be used to generate in-plane resonance and detection in this sensor.

Alternatively, as shown in the illustration 650 of the schematic expression of the d₃₃ piezoelectric mode in FIG. 6B (with substrate 666 and piezoelectric layer 668), if the top electrodes 660 are patterned following an IDE (Inter-Digitated Electrode) design, the electrical field 662 generated will be parallel to the deformation (see strain 670). In this case, the bottom electrodes 664 may serve as reflectors. This describes the d₃₃ mode, which may be used for the out-of-plane resonators in any one, any combination, or all of the gyro, accelerometer and PEH functions. On average, the d₃₃ coefficient, for a typical piezoelectric material, may be 2-3 times higher than the d₃₁ coefficient which, consequently, may improve the performance of this sensor device in terms of sensitivity for out-of-plane vibration detection. In this regard, the one or more mechanical elements are configured to drive and sense in-plane and out-of-plane movements.

Thus, the sensor may be used in various piezoelectric modes, as illustrated above. Further, in one or some embodiments, sputtering may be used for different patterns of electrodes in the different modes. As one example, with regard to d₃₁, sputtering may position the electrodes 620, 622 as illustrated in FIG. 6A to generate the field 630 as shown. As another example, with regard to d₃₃, sputtering may position the electrodes 660, 664 as illustrated in FIG. 6B to generate the field 662 as shown. Thus, different patterns of electrodes may be used in order to comport with the different piezoelectric modes.

In one or some embodiments, IDE electrodes may be used for any one, any combination, or all of drive, detection, or harvesting components. As one example, FIG. 6C is an illustration 671 of one or more IDE Electrodes that may be disposed on the piezoelectric traces 672 following three distinctive configurations, which may respectively be used on drive, detection and energy harvesting components. In the drive configuration, the IDE electrodes 674 may induce an alternate elongation and contraction of the piezoelectric layer at a certain frequency using the d₃₃ mode along the beam side creating an XY plane vibration 676. In detection configuration, IDE electrodes 678 may be patterned to detect only out-of-plane vibration and may cancel out any other modes of vibration. The energy harvesting configuration 680 may be identical to the detection configuration as it intends to capture energy from out-of-plane oscillations.

IDE electrodes' efficiency may be characterized by electrodes width (w) 682, gap (g) 684 and length (l) 686. With an adequate configuration, the piezoelectric material polarization may be largely improved, which may have a positive impact on the performance of the sensor. Merely by way of example, the parameters w and g may be established at 5 and 5 microns, respectively.

### Various Components and Related Functions

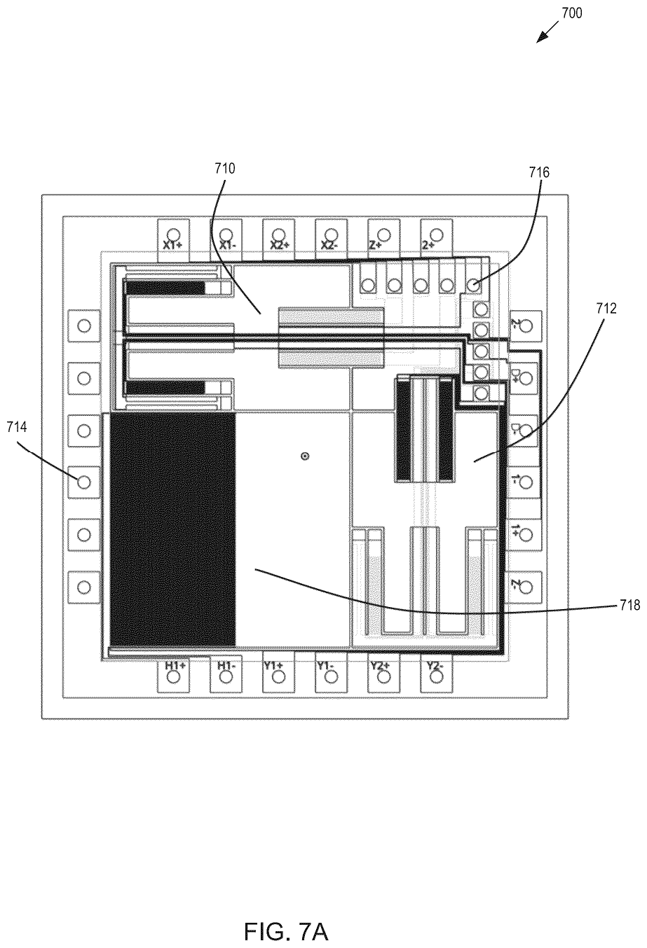

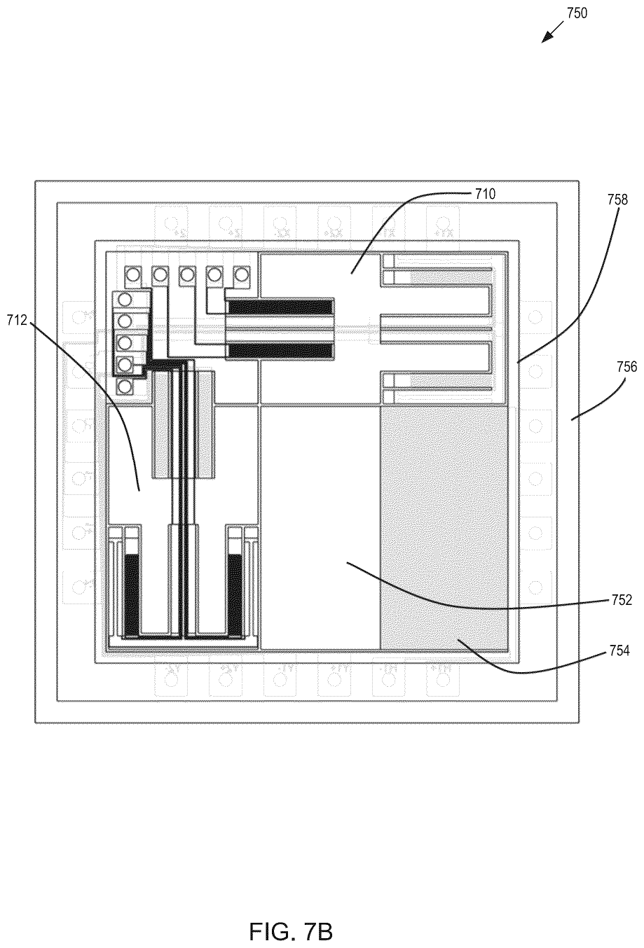

FIG. 7A illustrates a bottom view 700 of the IMU sensor and FIG. 7B illustrates a top view 750 of the IMU, Looking at the bottom view 700 in FIG. 7A, two orthogonal and E-shaped monolithic gyroscope-accelerometer 710, 712 are suspended by a pivot point to a support frame.

Some or all electric connections from the top may be routed to the connection pads 714 by metalized vias 716 that are etched through the support area. A piezoelectric energy harvester 718 may be suspended to a support frame by a thinner cantilever portion 754 that is plated with interdigitated electrodes to capture any electric potential generated by a piezoelectric layer. This cantilever portion is holding a thicker mass 752 that generates an inertial energy (such as an in-plane inertial energy) required to create strains in the piezoelectric material.

On both sides of the sensor, two Au—Sn eutectic seals having a width of 200 microns, may be patterned on a SiO₂ isolation layer. These two parallel and concurrent seals, one on the peripheric border 756 and one on the inner edge of frame 758, maintain the long-term vacuum condition while decreasing the mechanical deflection of the cover under such a vacuum.

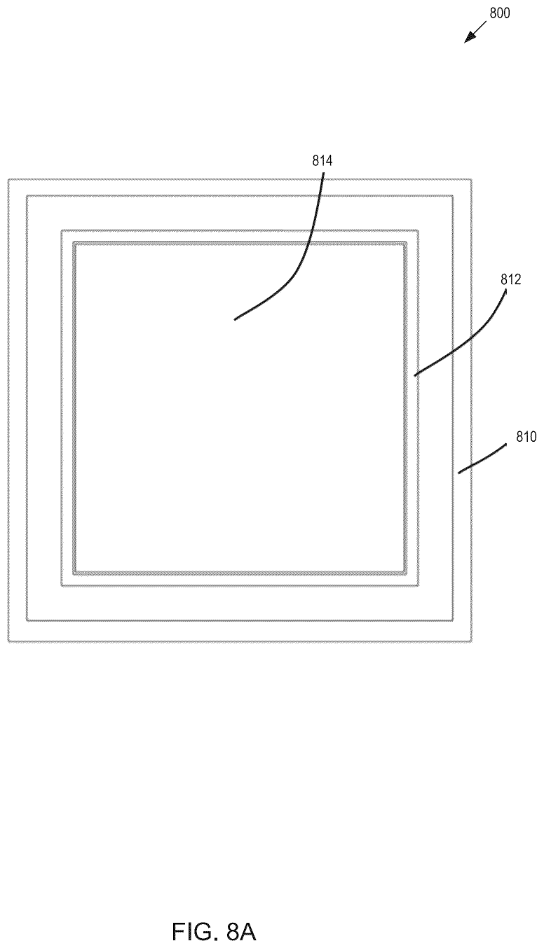

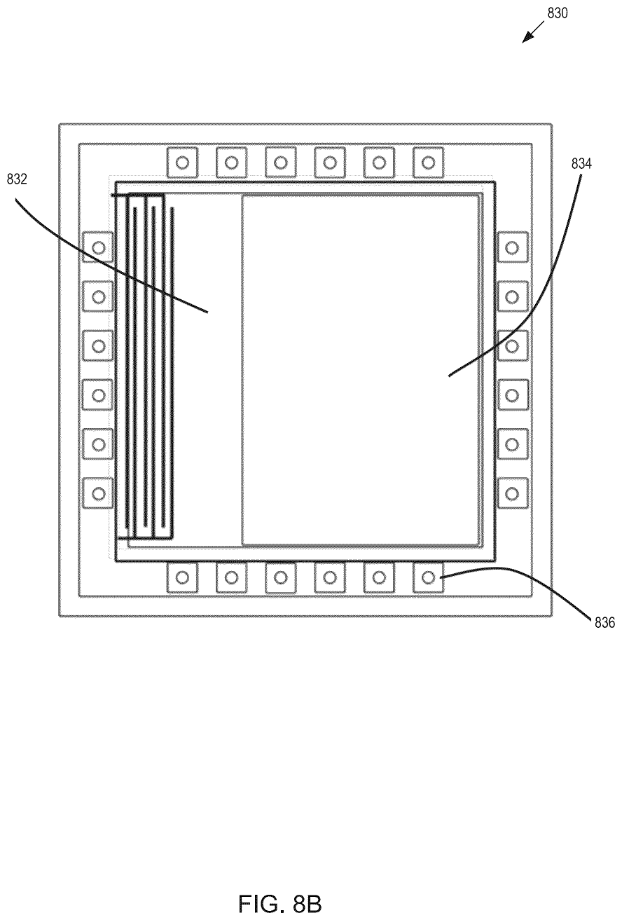

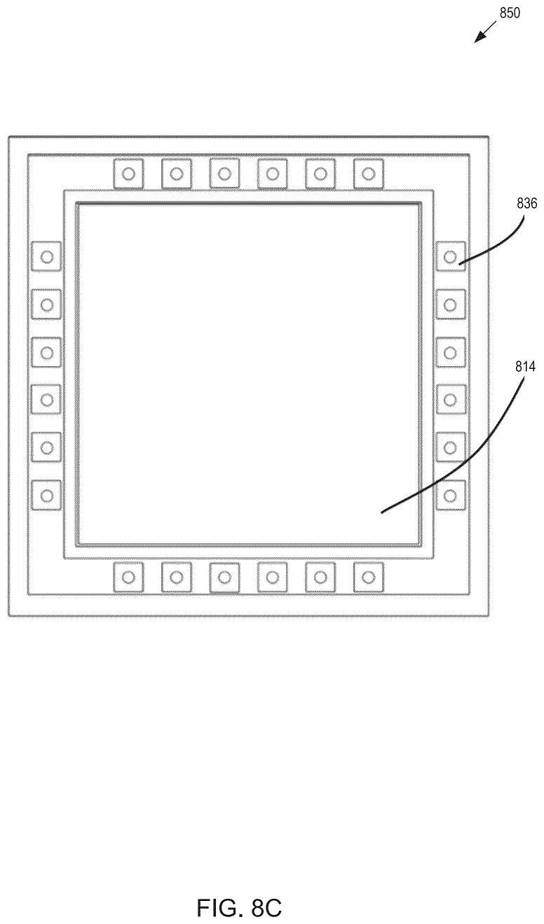

As shown in FIG. 3A, the sensor may be compressed at wafer-level under a vacuum with several layers that are detailed in FIGS. 8A-C, which are illustrations 800, 830, 850 of the top cover (bottom view), the piezoelectric energy harvester (bottom view), and the bottom cover (top view), respectively. Some or all of these layers may be sealed with parallel and concurrent eutectic seals 810, 812. Thus, in one or some embodiments, one or more of the layers may be sealed (such as at least partly encapsulated) on the wafer layer level. This may be due to the sensor being on a single layer, without the need for a cube or other larger structure to house the sensor.

The top and bottom covers (such as illustrated in FIG. 3A at 330, 320) may have a light cavity 814 in the center portion to provide additional spacing for a deflection of the suspended components. The bottom cavity may hold several passive and active electronic components that are integrated before an assembly at the wafer chip-scale level. In one or some embodiments, an optional PEH layer (such as illustrated in FIG. 3A at 310) may be formed with a thin cantilever portion 832, plated with a piezoelectric material and metallic electrodes, that is connected to a large suspended mass 834 which may be similar to the PEH 718, present at the sensor level (see e.g., 200, 360, 370). The optional PEH layer and bottom cover may have metalized vias 836 that may be etched through the frame to connect the metallic under bumps that may be later soldered to an electronic board. In one or some embodiments, a plurality of free vias, such as, for example, six free vias, may be reserved for additional PEH layers if required.

Thus, in one or some embodiments, one or more non-resonant piezoelectric energy harvester elements may be in a different plane from the one or more mechanical elements that is outside of a die area housing the one or more mechanical elements but inside a sealed electronic package housing the IMS.

### Material Composition and Manufacturing Details

Various material compositions and manufacturing details are contemplated. As one example, the IMU sensor may be composed of a plurality of micro-structured piezoelectric elements that may be micromachined using a silicon-on-insulator (SOI) base. Other substrate bases are contemplated such as glass, alumina, zirconia or polyimide. With this technology, the density of micro-structures and the wafer size may be largely increased compared to those from a solid-state piezoelectric wafer. Known microfabrication techniques and equipment may be used to produce the IMU sensor, which may include WLCSVP (Wafer Level Chip-Scale Vacuum Packaging) technics that may not be available for other types of substrates. This type of packaging, using large-size SOI wafers, may help to decrease the associated manufacturing cost.

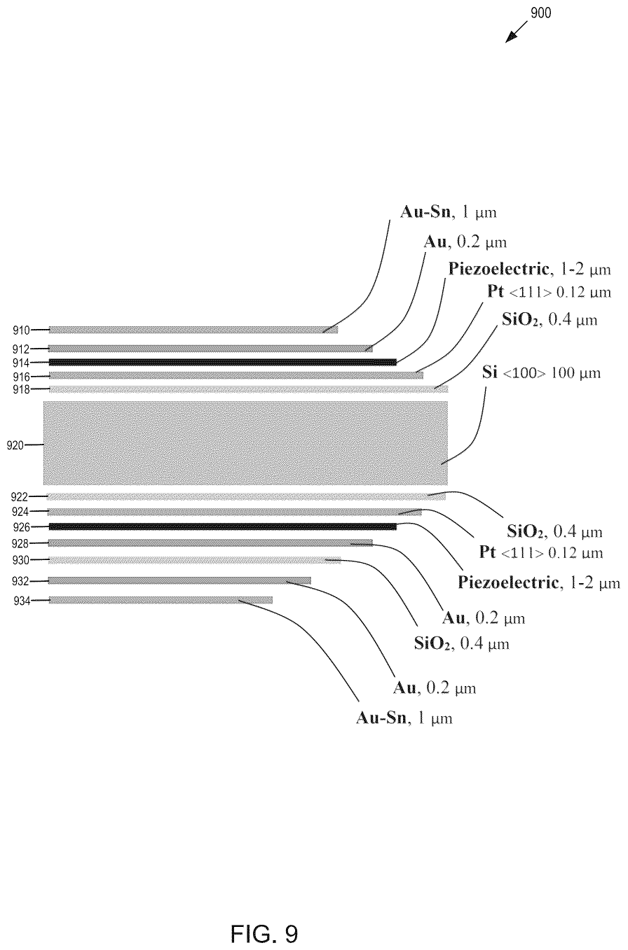

In one or some embodiments, as indicated in the illustration 900 in FIG. 9, the IMU sensor may use a standard silicon wafer 920 having a standard <001> orientation and a thickness between 78 and 100 microns that is coated with a proper insulating material, SiO₂, which may be obtained using a standard low-pressure vapor deposition process on both sides 918, 922 followed by a passive/active conducting material layer, which is platinum (Pt) 916, 924 with an <111> orientation. The selection of this interim conductive layer may be important because it may have a determinant influence on the crystallographic orientation of a piezoelectric material layer 914, 926 that may be either a ceramic-type like PZT (sol-gel form) or LbTio₃ or a wurtzite structure like ZnO or Li: ZnO, which may be a doped version of ZnO. Other piezoelectric materials are contemplated. In this regard, the use of other types of piezoelectric materials that may be applied, such as sputtered, in thin-film deposition, such as lead magnesium niobate-lead titanate (PMN-PT), are also contemplated.

The use of thin-film piezoelectric material for this type of sensor may represent a real improvement compared to prior sensors based on solid-state piezoelectric crystal because this sensitive material may be sputtered and patterned where it is only needed, which may decrease the possibility of noise contamination from unwanted structural vibrations. This is in contrast to crystal-based sensors that are unable to selective place the piezoelectric crystal.

On top of the piezoelectric layer, a conductive layer 912, 928 may be sputtered and patterned. In one or some embodiments, gold (Au) may be utilized as the top conductive layer, which may have proper compatibility and adherence to most piezoelectric materials. In one or some embodiments, a second glass insulator SiO₂ layer 930 and conductive layer 928 (which may be gold (Au)), may be used for some cross-connection of electrodes. In some areas, this additional insulation layer may be required under the Au—Sn layer 910, 934, which may be used to create a eutectic sealing of the assembly.

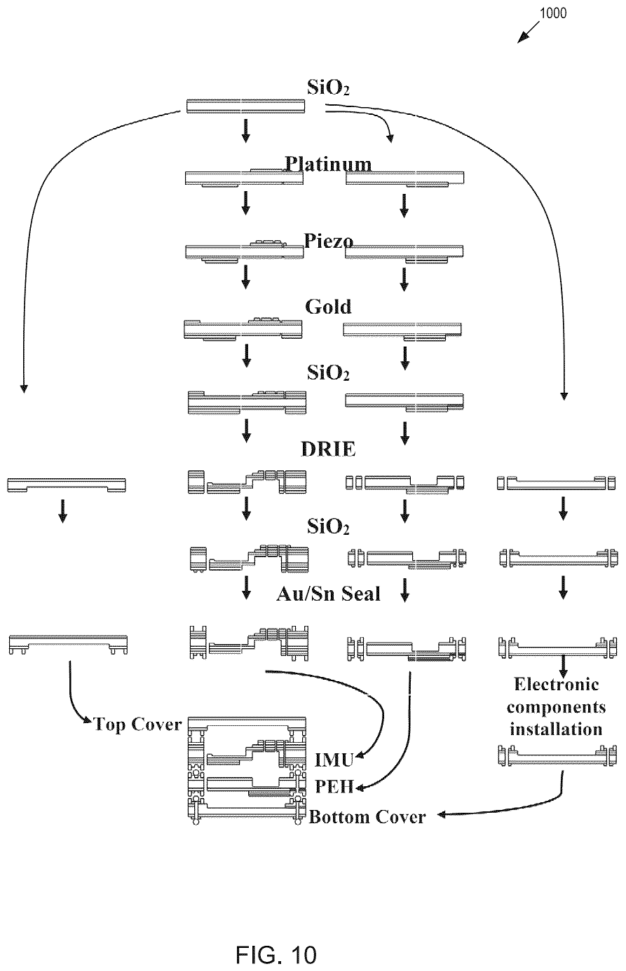

Furthermore, FIG. 10 is an illustration 1000 detailing the manufacturing steps that may be typical in the MEMS industry which may include any one, any combination, or all of: photoresist application; masking; UV exposition; cleaning; sputtering; lift-off patterning; and plasma etching by direct reactive ion technology. In one or some embodiments, the manufacturing steps may include a plurality of iterations of photoresist applications, maskings, UV expositions, cleanings, sputterings, lift-off patternings and plasma etchings by direct reactive ion technology. These iterations may be performed on one or both sides of the wafer so that no sacrificial layer technique need be utilized to increase the manufacturability of this sensor. A eutectic sealing of the assembly, which may comprise the top cover, IMU sensor, optional PEH interposers and a bottom cover, may be executed at low temperature in a specialized heating press under a 10⁻⁶ atm vacuum condition. The hermetic vacuum-sealed layered package, having a thickness of fewer than 400 microns, may then be laser-scribed for singularization. In one or some embodiments, orthogonality between the two independent E-shaped gyroscope-accelerometers that are placed in two separate layers in a smaller package, as illustrated in FIG. 3B, may be preserved because the assembly is made at the wafer level which may be done prior to the singularization. In this regard, one or more PEH interposer layers may be used to extract energy. The number of PEH interposer layers may determine the amount of energy harvester. As such, in instances where less energy is needed (e.g., to only power the sensor layer(s)), fewer PEH interposer layers, such as a single PEH interposer layer, may be used. In contrast, higher energy needs may result in a greater number of PEH interposer layers.

Thus, one or more mechanical elements may comprise a first planar structure gyroscope and a second planar structure accelerometer, with the first planar structure gyroscope being positioned at least partly (such as mostly) on a first layer of the IMS and the second planar structure accelerometer being positioned at least partly (such as mostly) on a second layer of the IMS, the second layer of the IMS being different than the first layer of the IMS.

### Gyroscopic and Accelerometer

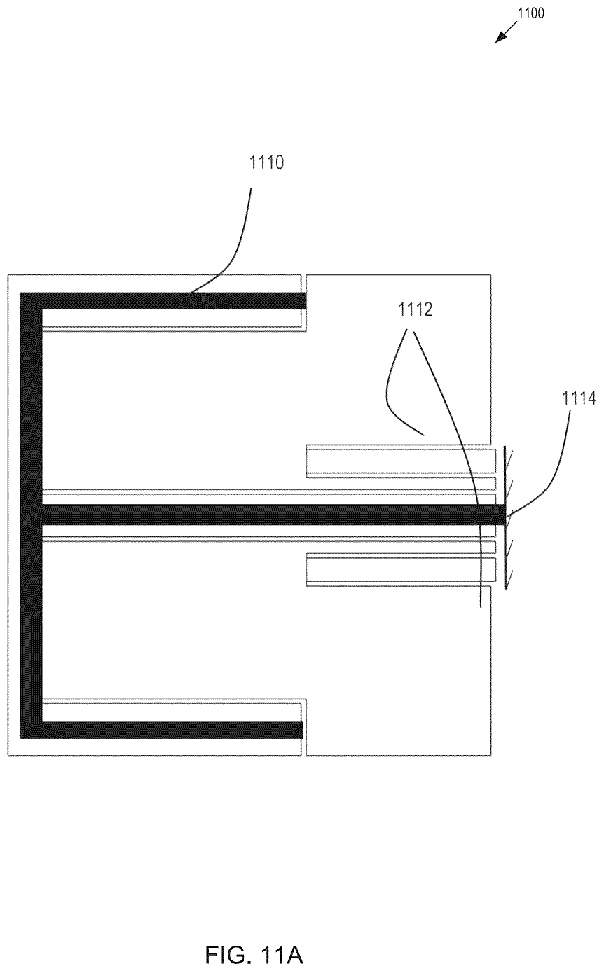

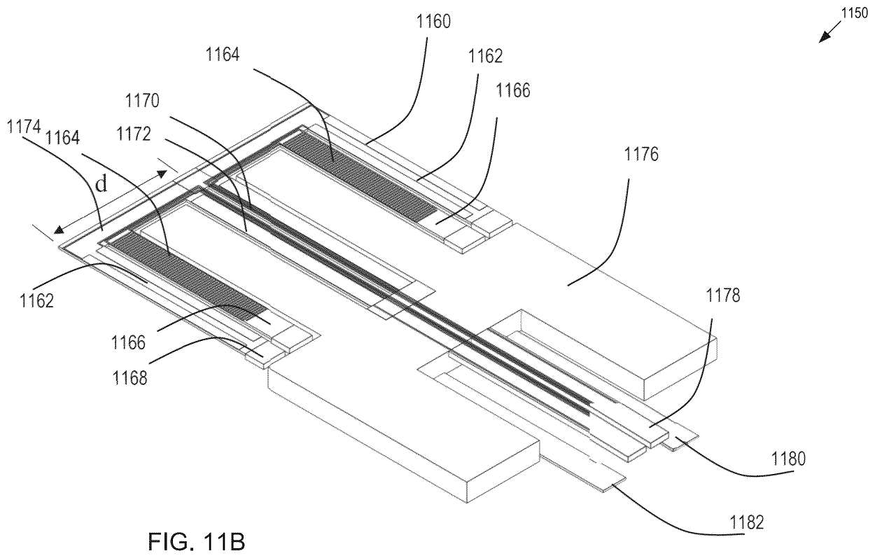

By definition, a monolithic structure indicates that no joint or assembly method need be required between two components from common support. As represented in the illustration 1100 in FIG. 11A, the E-shape gyroscope 1110 and accelerometer 1112 functions to form a monolithic structure that is suspended at one end 1114 to a support frame.

FIG. 11B is an illustration 1150 of an E-shaped structure which includes longitudinal electrodes 1160 that may be plated on one side, such as the top-side, of the gyro drives 1162, which may generate in-plane vibrations using a d₃₁ mode. Similarly, IDE electrodes 1164 may be plated on one side, such as the top side, of the detection resonators 1166, which may capture out-of-plane vibrations using a d₃₃ mode. Additional masses 1168 may be extruded at the end of the gyro drives and detection resonators to increase the inertial energy. For this sensor, such masses may increase the Coriolis effect by approximately half of the percentage of the mass increase.

A slitted arm 1170, which may also be plated longitudinally on the top side with electrodes 1172 to capture in-plane vibrations, may be parallel to the gyro drives 1162 (interchangeably termed gyro drive resonators or gyroscope drives) and detection resonators 1166. Traverse support 1174 connects the gyro drives 1162 and detection resonators 1166 at a distance d from the slitted arm 1170. This distance d may create an in-plane torque on the slitted arm 1170 when the sensor is rotated around a Z axis. The gyro components, including any one, any combination, or all of gyro drives 1162, detection resonators 1166, slitted arm 1170 and traverse support 1174, may have a thinner structure which may be etched on one side to increase the tip deflection of the gyro drives 1162 while generating more strains in the detection resonators 1166 which, in turn, may increase the gyro sensitivity because more voltage is created.

These structures may be suspended to a thick suspension arm 1176 having a substantial mass compared to the thinner suspended gyro structures. This suspension arm 1176 may also be suspended by a hinge 1178 attached to a support area. These hinges 1178 may serve as pivot points and passages for the metallic electrodes that are routed from the gyroscope portion to the connection pads. An arrangement of push-pull vibrating resonators 1180, 1182, that are vibrating out-of-plane, may be disposed on each side of these hinges 1178. These resonators 1180, 1182 may be covered with piezoelectric material and metallic IDE electrodes on the top side which are connected to a sinusoidal source of excitation. These top electrodes may be connected in such a way that an out-of-plane bending of the resonator 1180 is 180° shifted compared to the resonator 1182. This phase shift may decrease the overall vibration noise generated in the suspension arm 1176 and, consequently, in the gyroscope components, including any one, any combination, or all of gyro drives 1162, detection resonators 1166, slitted arm 1170 and traverse support 1174. Thus, in one or some embodiments, a drive resonator, such as a first drive resonator, may be configured to input a 180° shifted drive signal compared to that input to a second drive resonator.

The piezoelectric force 530 that individually drives vibrating members 1162, 1180 and 1182 using converse piezoelectric principles, previously explained in FIGS. 5, 6A, 6B, maintains resonance on these members with the surface tensions created by strains 640 or 670, creating the required cycling elongations and contractions which are sufficient and may be necessary to create a state of resonance in vibrating members 1162, 1180 and 1182.

The monolithic gyroscope-accelerometer 712 may be a perfect mirrored image (e.g., a mirrored in-plane image) at 45° of the monolithic gyroscope-accelerometer 710. Incidentally, as an example, a slitted arm 1170, which may be top anchored to the suspension arm 1176 in monolithic gyroscope-accelerometer 710, may be bottom clamped in gyroscope-accelerometer 712, which may be the same for the out-of-plane resonators 1180, 1182 in the accelerometer portion. Consequently, this mirrored copy of resonators 1180, 1182 may create a push-pull mechanism that is sensitive to acceleration along the Z axis as half of the resonators are top anchored while the rest is bottom anchored to the support area.

### Operation of the Gyroscope Function

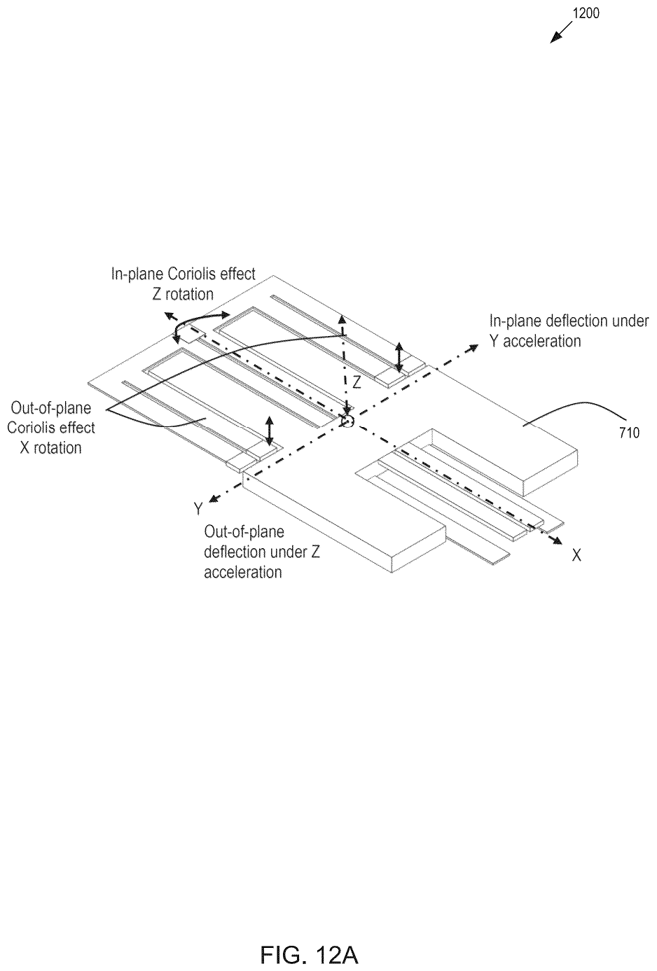

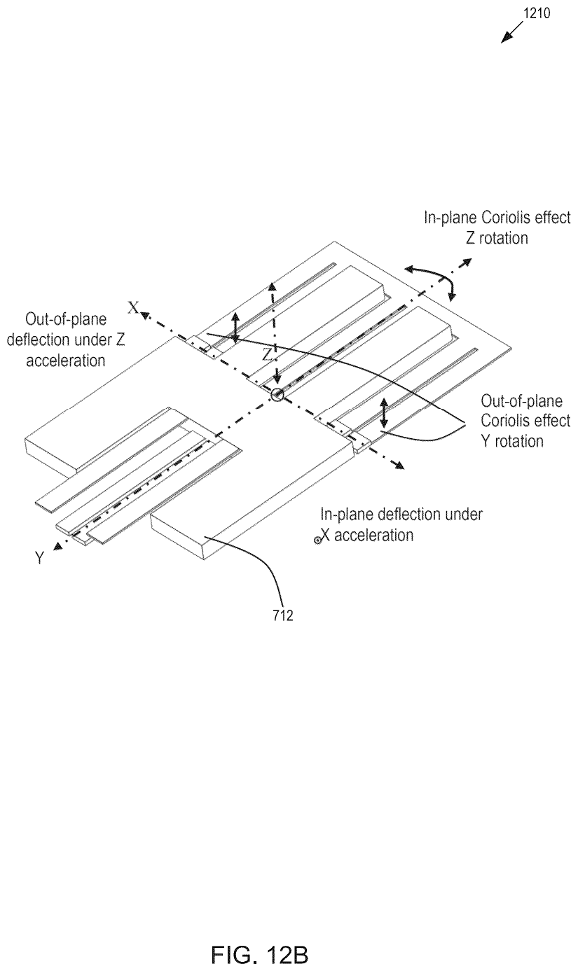

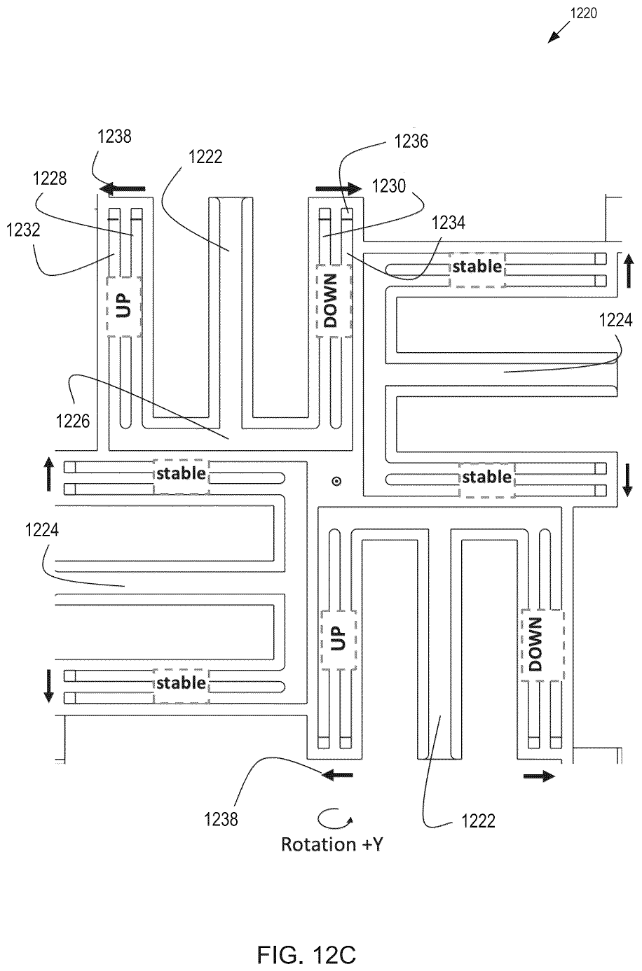

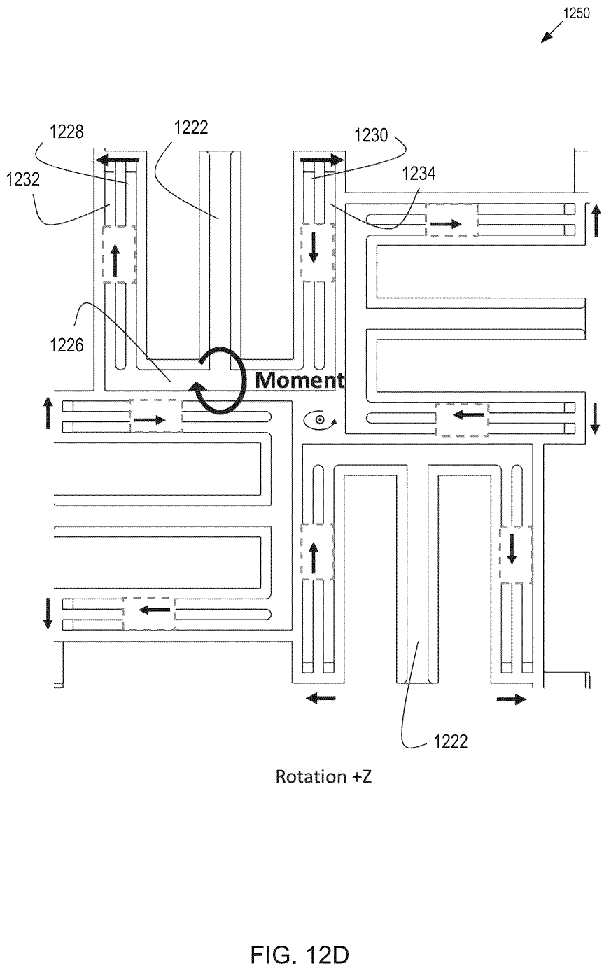

Various layouts of the hardware to implement the gyroscope function are contemplated. Examples layouts are illustrated in FIGS. 12A-D. For example, FIGS. 12A-B include illustrations 1200, 1210 of the sensitive axes for the monolithic gyroscope-accelerometer 710 and 712, respectively, that have an E-shaped structure. For the gyroscopic function, a sensitive axis may be determined by the right-hand rule considering the vectorial orthogonalities between the rotation axis, displacement axis and Coriolis force axis. As such, if the gyroscope drive direction is co-founded with a rotation axis, no Coriolis effect is produced. Inversely, if such a drive direction is perpendicular to a rotation axis, a maximal Coriolis effect is generated. Consequently, as indicated, an out-of-plane Coriolis effect is generated for the monolithic gyroscope-accelerometer 710 when a rotation occurs around X while a rotation around Y is detected by the gyroscope-accelerometer 712.

FIGS. 12C-D are illustrations 1220, 1250 of another example of the gyro function. Specifically, FIG. 12C illustrates various elements that are stable and other elements that are subject to movement. For example, the gyro function may be composed of two sets of suspended Z detection beams 1222, 1224, which may be the detection arms for rotation around the Z axis. The two sets of suspended Z detection beams 1222, 1224 may be aligned to an orthogonal axis X or Y. In one or some embodiments, each of these Z beams may support a transversal & perpendicular support 1226 (or perpendicular plate) from which may be attached one or both of the drive beams 1232, 1234 and detection beams, 1228, 1230, which may be the detection membranes for rotation around any axis in the XY plane. In one or some embodiments, these may be both perfectly aligned with the Z detection beams 1222 and/or 1223. In one or some embodiments, at the end of one or both of the drive and detection beams, additional tip masses 1236 may be attached to increase the deflection of the beam during oscillation. As discussed above, the tip masses 1236 may be at an end of a respective beam (e.g., on less than 50% of the respective beam, on less than 40% of the respective beam, on less than 30% of the respective beam, on less than 20% of the respective beam, on less than 10% of the respective beam, on less than 5% of the respective beam, etc.). For such a configured sensor, a mass addition of x % may increase the Coriolis force by ½ x %.

Of note, in one or some embodiments, the opposite vibrating directions with equal amplitudes of the two drive beams 1232, 1234 may create no in-plane vibration stress on the Z detection beam 1222. This synchronicity may reduce de facto the electric noise on the Z detection beams. As an example, using FIG. 12C, with the direction of vibration 1238 and the right-hand rule to determine the vectorial Coriolis force direction, the detection beams 1228, 1230 that are linked to a transversal beam attached to the Z detection beam 1222 may have maximal out-of-plane vibration when the sensor is rotated around the Y direction. Similarly, the detection beams suspended by the Z detection beams 1224 may have maximal out-of-plane vibration when a rotation occurs in the X direction.

In one or some embodiments, one, some or all Z detection beams (such as the four Z detection beams illustrated in FIGS. 12C-D) may vibrate during rotation around Z axis. FIG. 12D is an illustration 1250 of an example of torque generated by the vibrating beams in resonance when the sensor is rotated around the Z axis. Due to the opposite direction of vibration of beams, including drive beams 1228, 1230 and drive beams 1232, 1234, a net torque may be generated on the perpendicular support 1226 due to the Coriolis force. This alternating torque may be generating in-plane vibrations in the Z detection beam 1222, as an example.

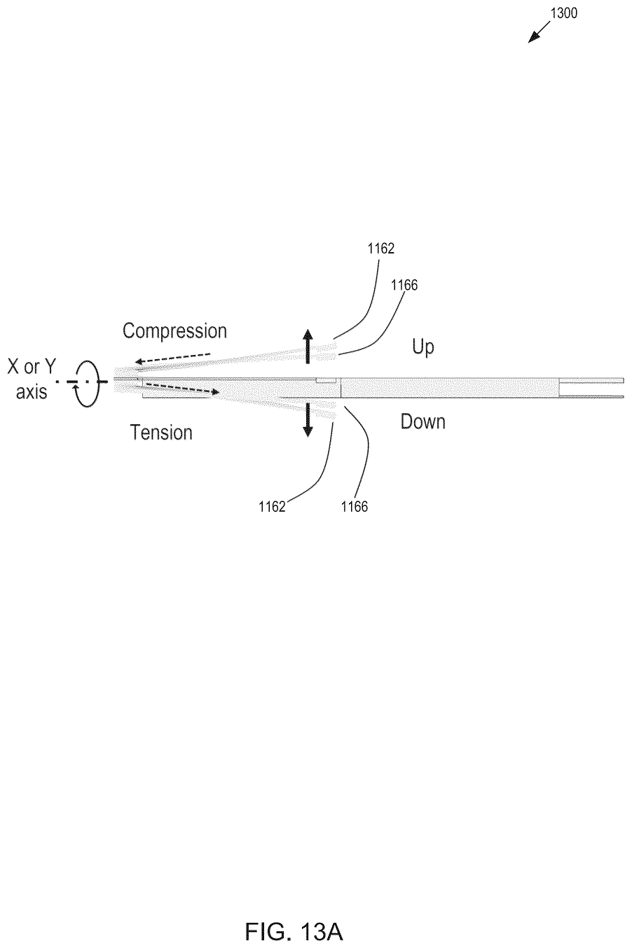

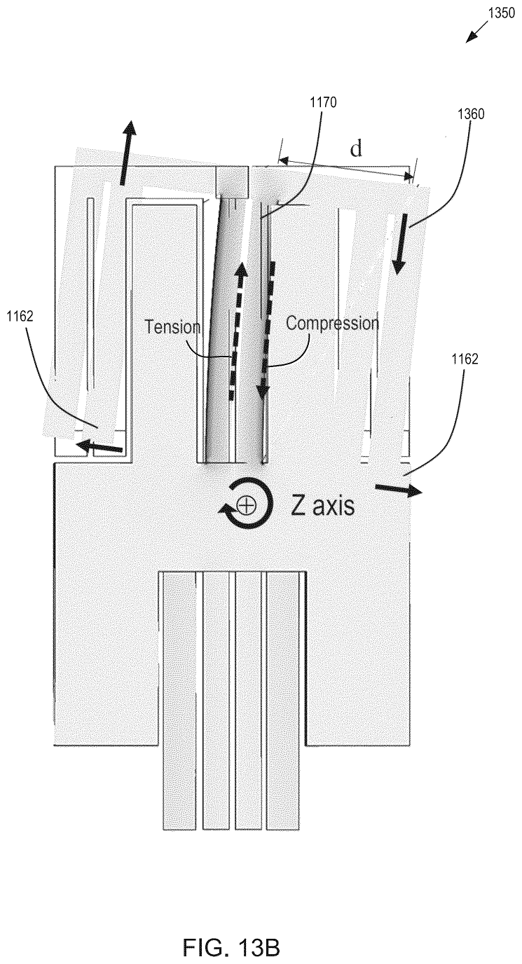

An illustration 1300 of the Coriolis effect on the detection resonators when a rotation occurs in the XY plane is shown in FIG. 13A, which is a side view of the gyroscope portion having opposite out-of-plane displacements of the gyro drive 1162 and detection resonators 1166. Also, both E-shaped gyroscopes are sensible to a rotation around Z while producing an in-plane vibration in the slitted arm 1170 due to the orthogonal Coriolis effect 1360 having a mechanical advantage created by the distance d from the gyro drives 1162 which is shown in illustration 1350 in FIG. 13B.

The deflection of these detection resonators may cause an alternative strain in the plated piezoelectric material, which may generate a voltage proportional to the rate of rotation Ω.

In this sensor, assuming the angular rate of rotation Ω to be neglectable compared to the angular velocity of the gyro drives, the governing equations of motion for the gyro portion, based on Newtonian mechanics, may be described by:

$$m \frac{{d}^{2} i}{dt} + {c}_{i} \frac{di}{dt} + {k}_{i} i - 2 m Ω \frac{dj}{dt} - {F}_{i} = 0 m \frac{{d}^{2} j}{dt} + {c}_{j} \frac{dj}{dt} + {k}_{j} j - 2 m Ω \frac{di}{dt} - {F}_{j} = 0 \qquad ( 3 )$$

where i, j are the orthogonal axis X, Y or Z, m is the mass of a piezoelectric drive, and c and k are, respectively, the damping and spring constants along the indicated axis. Based on (3), assuming there is no other force applied nor initial displacement, the only force that contributes to deflection along an axis j, that is orthogonal to a drive axis i, is related to the velocity of a drive resonator in the i direction which is found in the term:

$$- 2 m Ω \frac{di}{dt} \qquad ( 4 )$$

that is referred to as Fc, the Coriolis force, which is a vectorial product perpendicular to an axis i. This force, based on the law of conservation of momentum, causes an energy transfer called precession from one axis to another.

Therefore, this precession may be causing a sinusoidal bending in the gyroscope resonators which, in turn, may generate vibrations in the sense detectors. In one or some embodiments, a voltage may be sensed by sensing element(s) 112 in one of several ways. In one way, as shown in FIGS. 6B, 6C, a sinusoidal voltage may be captured in the electrodes, which are plated on the piezoelectric material. In particular, the sinusoidal voltage, sensed by the electrodes, may be generated due to the strains in the piezoelectric material which is created by these nanoscopic out-of-plane vibrations. In one or some embodiments, the amplitude of this voltage signal may be directly related to the strains on the piezoelectric material caused by the rate of rotation causing the sense detectors' deflection, and is one example of a sensing element. Referring to FIG. 4A, this mechanical stress on detection member 440 may be due to the deflection of resonators 420 caused by the Coriolis force 412.

More particularly and based on mechanical Euler-Bernoulli beam theories, this deflection may be described as:

$$γ = \frac{( - 2 m Ω \frac{di}{d t} ) {L}^{3}}{3 EI} \qquad ( 5 )$$

for a vibrating cantilever beam detector having a length L, where E is the young modulus (GPa) of a composed beam material which includes a piezoelectric material and several metallic layers. It is noted that such beam deflection is largely related to its length L. The second moment of inertia I (m⁴) in the bending direction may be different for an in-plane or an out-of-plane bending due to the dimension parameters, as following:

$${I}_{i} = \frac{1}{12} t {w}^{3} , for in - plane vibrations , and {I}_{o} = \frac{1}{12} w {t}^{3} , for out - of - plane vibrations . \qquad ( 6 )$$

In this sensor, based on Equations (5) and (6), the detection resonators, having a thickness t smaller than a width w, have larger out-of-plane displacement which may occur when the sensor is rotated around an axis in the XY plane. Inversely, the in-plane resonance frequency f may be higher compared to the out-of-plane resonance frequency, which may be estimated by:

$$f = \frac{1}{2 π} \sqrt{\frac{k}{m}} \qquad ( 7 )$$

where the spring constant k, which may be described by a force F divided by a deflection γ, is, referring to Equation (5), proportional to I by definition, as following:

$$k = \frac{F}{γ} = \frac{3 EI}{{L}^{3}} \qquad ( 8 )$$

with Equation (8) in Equation (7), the resonance frequency of such cantilever resonators may be estimated by:

$$f = \frac{ω}{2 π} = \frac{{n}^{2}}{2 π} \cdot \sqrt{\frac{3 {E}_{c} I}{m {L}^{3}}} \qquad ( 9 )$$

where n² is a coefficient related to the eigenmode of resonance (for the primary mode, n=1.875).

Based on Equations (6) and (9), this sensor may use resonant drive resonators and non-resonant sense detectors (e.g., performing a non-resonant sensing function) due to a difference in the second moment of inertia for the in-plane and out-of-plane bendings. This may contribute to decreasing unwanted cross-axis signals that may mostly be present in a capacitive gyroscope in the prior arts, which may require perfect resonance frequency matching between drive and sense function to operate properly. In practice, due to some unwanted asymmetries and small manufacturing deviations affecting capacitance from movable masses and electrodes gap, this perfect adequation may not be realizable, which, in turn, may lead to performance degradation that is not present in the disclosed sensor.

In one or some embodiments, the electric signals, generated by the detection beams, may be linked to the g₃₃ piezoelectric voltage constant (in Vm/N) that may be expressed as:

$${g}_{33} = {( \frac{\partial {E}_{i}}{\partial T} )}^{D}$$

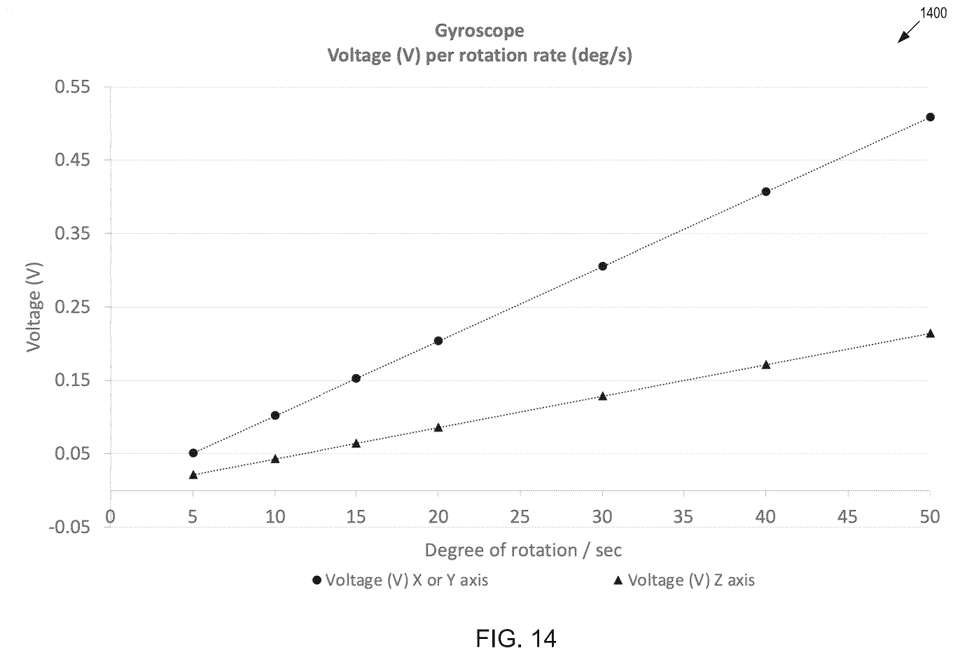

Hence, a peak signal voltage (e.g., Sine voltage) from a piezoelectric material may be created when maximal stress is reached during a sinusoidal bending. Such peak signal voltages may be evaluated as:

$${V}_{max} = {g}_{33} \frac{( {F}_{c} d )}{2 I} {t}_{p} \qquad ( 10 )$$

where (F_{c}d) is the moment created by a Coriolis force acting at a distance d from the detection beam center and tₚ is the piezoelectric material thickness. The voltage generated may be linearly proportional to the rate of rotation 22, as indicated in the graph 1400 in FIG. 14.

### Operation of the Accelerometer Function

In one or some embodiments, the accelerometer portion may be based on a suspended mass system that induces some axial constraints on vibrating elements that are arranged in a push-pull configuration. For the accelerometer function, one or both gyroscope-accelerometer assemblies may be sensible to acceleration following the Z axis. For acceleration in the XY plane, the sensitive axis, for each monolithic gyroscope-accelerometer, may be determined when the only possible movement of the structure is in the direction of the acceleration. Moreover, an acceleration following the Y axis may cause a centroid deflection of monolithic gyroscope-accelerometer 710 while structure 712 will be deflected by an acceleration along the X axis in the XY plane.

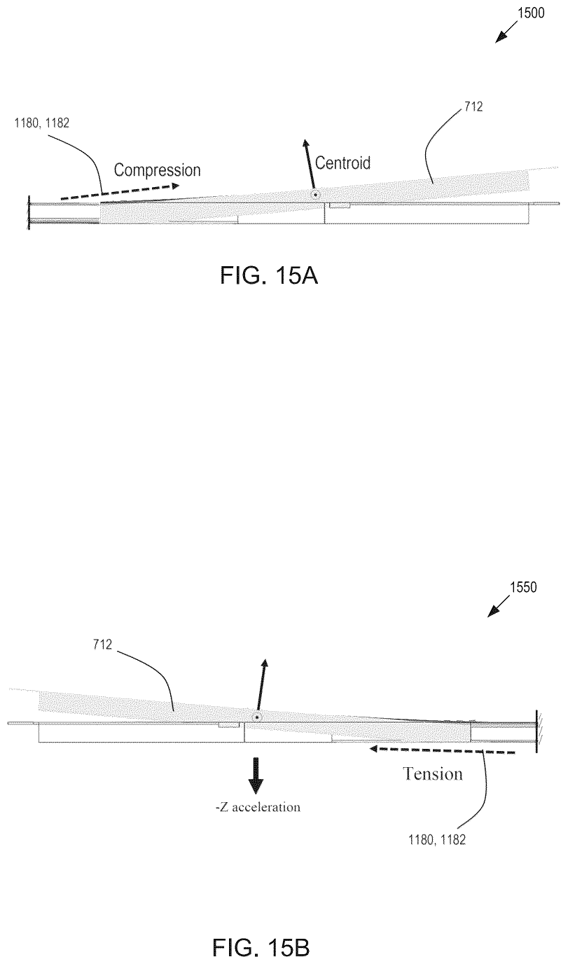

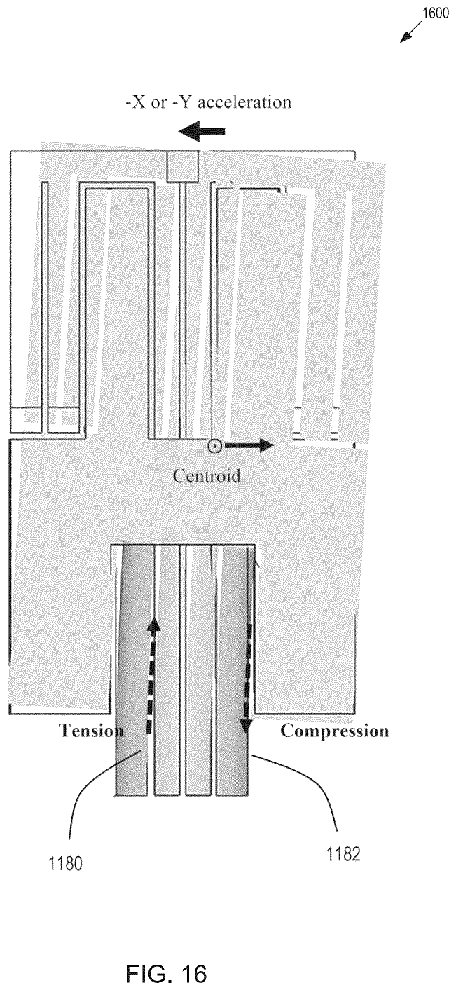

FIGS. 15A-B includes illustrations 1500, 1550 showing the push-pull effect on resonators 1180 and 1182 when the sensor is accelerated following the −Z axis, as an example. The centroids of the gyroscope-accelerometer assemblies are then deflected which creates a compression force in the top-anchored resonators of structure 712 and a tension force in the bottom-anchored resonators of monolithic gyroscope-accelerometer 710.

Also, a movement following a sensitive axis in the XY plane creates a deflection of the centroid in the opposite direction of the displacement, as indicated in illustration 1600 in FIG. 16. This displacement creates tension and a compression force in the resonators 1180 and 1182, respectively.

Mathematically, referring to Equation (3), this accelerometer may operate under conditions at equilibrium that may be modeled as:

$$m \frac{{d}^{2} i}{dt} + {c}_{i} \frac{di}{dt} + {k}_{i} i - {F}_{i} = 0$$

where i is a possible axis of displacement of the accelerometer structure which is limited by a hinge 1178 in one direction, m is the suspended mass, Fi is the resultant force along a displacement axis i. In this sensor, there may be a mechanical advantage n created by the centroid and resonator distances to the hinge 1178, which may act with a mass m and an acceleration a, to create an axial force Fi that is exerted on resonators 1180 and 1182. As an example, and as previously explained in FIG. 4B, the inertial force 466 exerts a tension 472 that increases the resonance frequency on resonator 468 while decreasing the resonance frequency on resonator 470 due to the inertial force 466, which creates a frequency shift between the two vibrating members, which may be sensed by sensing element(s).

The resonance frequencies of resonators 1180 and 1182 may be influenced by such axial forces. Using a mechanical energy analysis from Rayleigh's theories, this frequency fₛ, for a clamped-clamped resonator with an axial constraint Fᵢ, may be expressed as:

$${f}_{s} = {kf}_{0} \sqrt{1 + [ \frac{{F}_{i} {L}^{2}}{{π}^{2} {E}_{c} I} ]} \qquad ( 11 )$$

where f₀ is the natural frequency of a resonator without axial force and k=4.73 is a proportion factor for the clamped-clamped boundary condition of the accelerometer resonator. By symmetricity, with Fᵢ=Fⱼ=ηma:

$$∇ {f}_{s} = {kf}_{0} ( \sqrt{1 + [ \frac{η ma {L}^{2}}{{π}^{2} {E}_{c} I} ]} - \sqrt{1 - [ \frac{η ma {L}^{2}}{{π}^{2} {E}_{c} I} ]} )$$

Hence, the frequency shift ∇fₛ is largely dependent on the length of the vibrating resonators 1180 and 1182, which may have a large influence on the accelerometer's sensitivity. In one or some embodiments, the accelerometer may measure quasi-static-state conditions in a non-dynamic environment. Because of a push-pull design, the sensitivity may be doubled (e.g., at least doubled) and spurious thermal effects, manufacturing deviances and other pre-stressed conditions, that may be present in the vibrating resonators, may be reduced or cancelled out by the subtracting operation. By way of example, when accelerating in the Z direction, certain arm(s) may be under constraint whereas other arm(s) may be pulled. In one or some embodiments, due to the symmetry of the structure (e.g., one arm is attached to the top of the support frame and another arm is attached to the bottom of the support frame), variations of temperature or the like may be reduced or canceled. As another example, symmetry in the X-Y plane (on the single layer) may likewise cancel various deviations in temperature or the like.

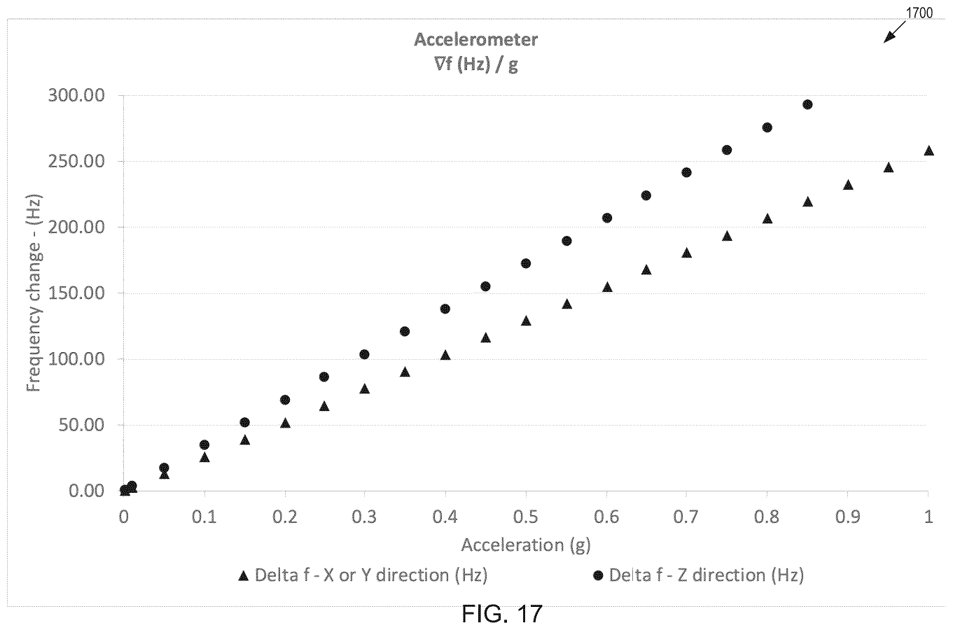

Along a sensitive axis, the resulting ∇fₛ is proportional to the acceleration a, as indicated in illustration 1700 in FIG. 17. More specifically, for a sensitive axis along X or Y, the frequency shift between resonators, disposed on each side of a center hinge, may be proportional to acceleration along this sensitive axis. Also, the difference between the sum of frequencies from the top resonators and the sum of frequencies from the bottom resonators may be proportional to the acceleration along the Z axis.

This frequency shift may be converted in voltage (V), either by an analog frequency-to-voltage converter or digital electronics via a microcontroller unit while the voltage sign provides the + or − direction on the axis.

### Piezoelectric Energy Harvesting Function

In one or some embodiments, a function, such as a primary function, of the inertial sensor is to convert at least a part of the inertial energy into proportional electric signals to measure a rate of rotation and acceleration about the orthogonal axis. The level of energy (W) required to operate the sensor may be a function of a complex Q factor loss, which may include mechanical losses in the structure. While this sensor may be intended to be used in a relatively dynamic environment, a piezoelectric energy harvester function may be incorporated, thanks to the very small footprint of the gyroscope-accelerometer function, to transform the ambient motion and vibration energy into usable electric energy. The electric energy may be used in a variety of ways, such as to be recycled to recharge a battery, for example.

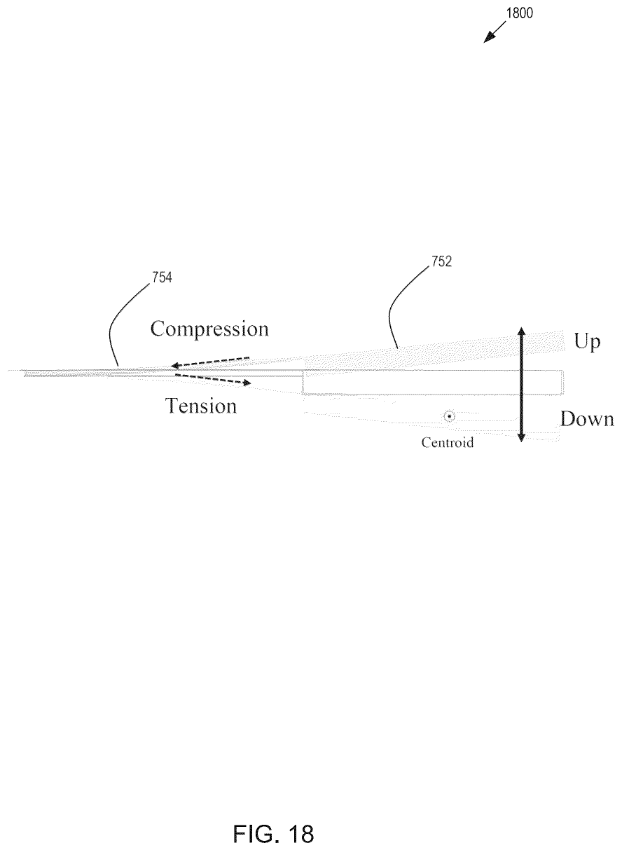

As discussed above (e.g., see FIG. 3B), one or more PEH layers (e.g., up to four additional PEH layers) may be added within the package to increase the potential inertial energy extracted. In one or some embodiments, energy may be used to operate the sensor, such as to create mechanical vibrations of at least a part of the sensor, such as the resonators. In this regard, the energy may be converted into mechanical vibrations. In turn, the mechanical vibrations may be used by the one or more PEH layers in order to convert the mechanical vibrations into electrical energy (e.g., for recharging the battery). Referring to the illustration 1800 in FIG. 18, the non-resonant PEH system includes a suspended mass 752 linked to a thinner cantilever support 754 attached to the support frame. With the inertial energy, this thin cantilever support may bend up and down, creating constraints in the top piezoelectric layer, which may create a dynamic polarization that is sensed by large IDE electrodes.

In one or some embodiments, the harvested power may completely depend on the ambient energy's nature in terms of frequency (f) and acceleration magnitude (a).

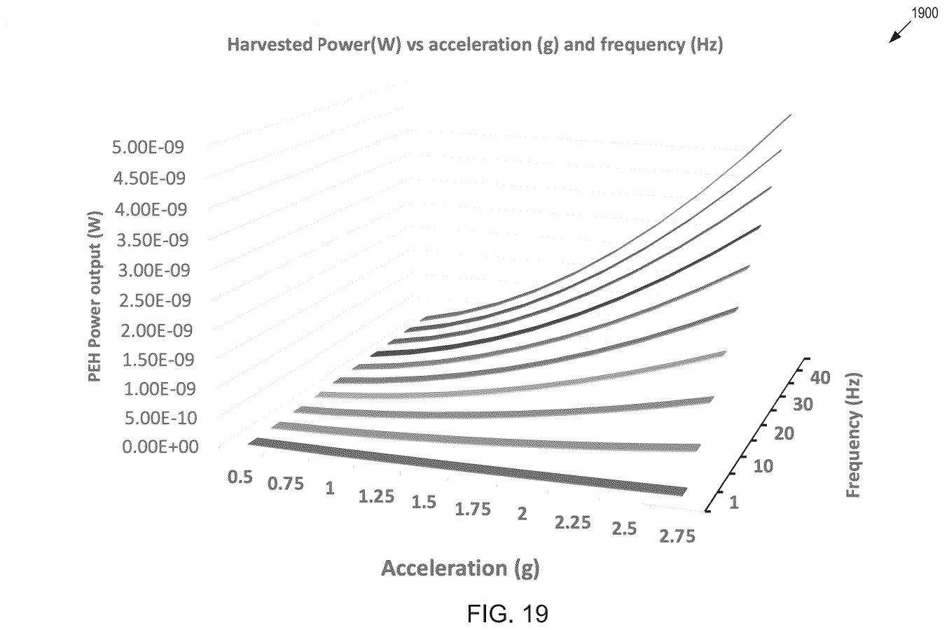

The power output (W) of n embedded PEHs (Piezo Energy Harvester) connected in parallel, as presented in the graph 1900 in FIG. 19, may be described as a function of:

$${P}_{a v g} ( in Watt ) = IV = {\sum }_{i = 1}^{n} \frac{dQv}{dt} = {\sum }_{i = 1}^{n} 12 π t ( \frac{f}{{w}_{i} {h}_{i}^{3}} ) {( {m}_{i} a {L}_{i} )}^{2} {d}_{33} {g}_{33}$$

which may consider the vibrating environment conditions characterized by a frequency (f) and an acceleration (a). These conditions may be assumed to be identical across all the PEH (n). The PEHs dimensions influencing the harvested power may be any one, any combination, or all of: the thickness (t) of the piezoelectric material; the suspended mass (mᵢ); the profile of the cantilever segment (wᵢ,hᵢ); or the distance to their respective centroid (Lᵢ).

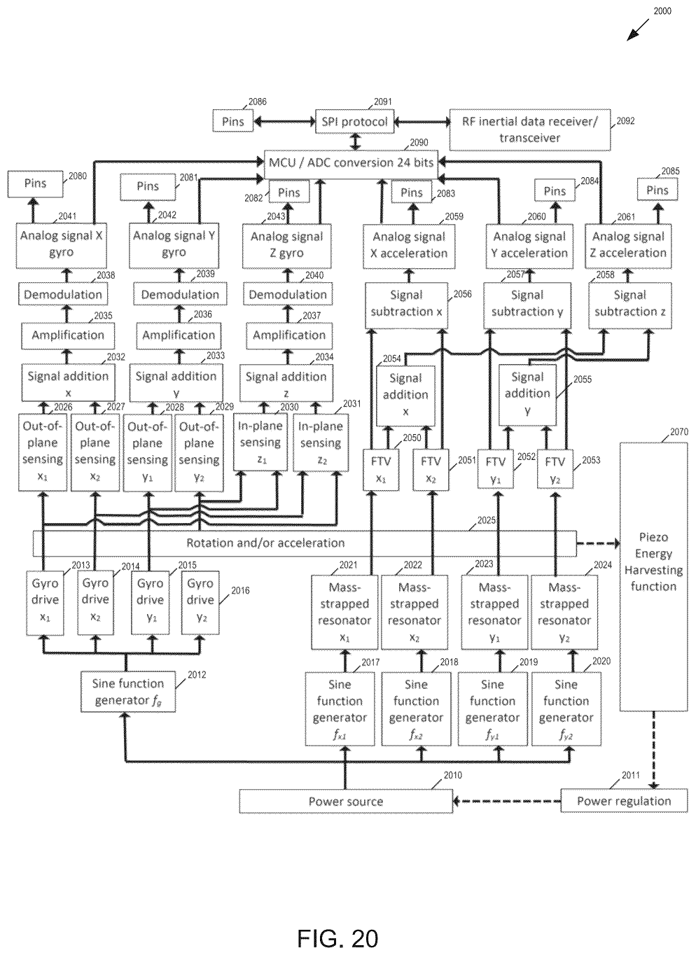

As discussed above, the IMU sensor may be implemented in one or several ways. In one way, the IMU sensor may be resident on a microchip with a plurality of pins (e.g., I/O pins), an example of which is illustrated in the block diagram 2000 in FIG. 20. For example, in one or some embodiments, the microchip may include operate one or both of a gyroscope or an accelerometer (driven by various signals generating by power source 2010) and may further include communication functionality (e.g., an RF function that may operate as one or both of a receiver and transmitter). In particular, a power source 2010 may power one or more parts of the microchip. In one or some embodiments, the power source may be powered via piezo energy harvesting function 2070 (which may harvest power from piezo electric energy in rotation and/or acceleration 2025, such as described herein), thereby generating power, which in turn may be routed to power regulation 2011 prior to routing to power source 2010.

In one or some embodiments, power source may generate one or more signals to drive one or both of the gyroscope or the accelerometer. For example, power source 2010 may drive one or more functions, such as sine generator functions, to drive one or both of the gyroscope or the accelerometer. In particular, FIG. 20 illustrates sine function generator f_{g} 2012, which in turn may drive one or more gyro drives, such as gyro drive x₁ 2013, gyro drive x₂ 2014, gyro drive y₁ 2015, gyro drive y₂ 2016. In turn, any one, any combination, or all of x, y, or z of the gyro may be sensed. For example, in one or some embodiments, out-of-plane may be sensed for one or both of x or y. Alternatively, or in addition, in-plane sensing may be performed for z. Thus, in one or some embodiments, gyro sensing may comprise any one, any combination, or all of: out-of-plane sensing x₁ 2026; out-of-plane sensing x₂ 2027; out-of-plane sensing y₁ 2028; out-of-plane sensing y₂ 2029; in-plane sensing z₁ 2030; or in-plane sensing z₂ 2031. Thus, FIG. 20 illustrates that sensing for each of x, y, and z uses two signals. Alternatively, only 1 signal for one, some, or each of x, y, and z may be used. After which, signals may be added for one, some, or each respective axis, such as: signal addition x 2032 for adding signals from out-of-plane sensing x₁ 2026 and out-of-plane sensing x₂ 2027; signal addition y 2033 for adding signals from out-of-plane sensing y₁ 2028 and out-of-plane sensing y₂ 2029; and signal addition z 2034 for adding signals from in-plane sensing z₁ 2030 and in-plane sensing z₂ 2031.

In one or some embodiments, amplification for the respective added signals may be used, such as using amplification 2035 for the output from signal addition x 2032, amplification 2036 for the output from signal addition y 2033, and amplification 2037 for the output from signal addition z 2034. Further, in one or some embodiments, demodulator(s) 2038, 2039, 2040 may be used, whose output may be routed to the respective analog signal for each of X, Y, and Z (see analog signal X gyro 2041, analog signal Y gyro 2042, and analog signal Z gyro 2043). For example, the demodulator may extract an original information-bearing signal from a carrier wave that may be output from the respective amplifiers. In turn, the respective analog signals may be routed to one or both of pins 2080, 2081, 2082 and/or to computing functionality (e.g., a microcontroller (MCU) or other type of computing functionality) and analog-to-digital (ADC conversion. For example, analog signal X gyro 2041, analog signal Y gyro 2042, and analog signal Z gyro 2043 may be routed to MCU/ADC conversion 2090 (to, for example, 24 bits).

Alternatively, or in addition, the IMU sensor may include accelerometer functionality. As such, one or more functions, such as sine functions, may drive one or more parts of the accelerometer. In turn, the response may be sensed, such as the frequency (frequencies) may be sensed, such as by one or more resonators (e.g., mass-strapped resonators). In particular, as shown in FIG. 20, sine function generator fₓ₁ 2017 may drive the portion of the accelerometer in a first x-direction, with the mass-strapped resonator x₁ 2021 sensing in the first x-direction, sine function generator fₓ₂ 2018 may drive the portion of the accelerometer in a second x-direction, with the mass-strapped resonator x₂ 2022 sensing in the second x-direction, sine function generator f_{y1} 2019 may drive the portion of the accelerometer in a first y-direction, with the mass-strapped resonator y₁ 2023 sensing in the first y-direction, and sine function generator f_{y2} 2020 may drive the portion of the accelerometer in a second y-direction, with the mass-strapped resonator y₂ 2024 sensing in the second y-direction. In turn, respective signals from the mass-strapped resonators may be fed to one or more frequency-to-voltage (FTV) converters (see output from mass-strapped resonator x₁ 2021 fed to FTV x₁ 2050; mass-strapped resonator x₂ 2022 fed to FTV x₂ 2051; mass-strapped resonator y₁ 2023 fed to FTV y₁ 2052; and mass-strapped resonator y₂ 2024 fed to FTV y₂ 2053). Further, the output from the FTV converters may be sent to one or both of signal addition or signal subtraction for combining and/or noise cancellation. In particular, as shown in FIG. 20, FTV x₁ 2050 and FTV x₂ 2051 are routed to both signal addition x 2054 and signal subtraction x 2056. Likewise, FTV y₁ 2052 and FTV y₂ 2053 are routed to both signal addition y 2055 and signal subtraction y 2057. In addition, the output of the respective signal subtraction may comprise the respective analog signal acceleration (see output of signal subtraction x 2056 to analog signal X acceleration 2059; output of signal subtraction y 2057 to analog signal y acceleration 2060).

In one or some embodiments, the outputs of signal addition x 2054 and signal addition y 2055 may be routed to signal subtraction z 2058, which in turn may generate as an output the analog signal z acceleration, which is routed to analog signal Z acceleration 2061.

As shown in FIG. 20, the various input and/or outputs may be routed to respective pins and/or may be routed to RF inertial data receiver/transceiver 2092 for wireless communication. In this regard, in one embodiment, the various values may be accessed by respective pins (e.g., analog signal X acceleration may be accessed via pins 2082; analog signal y acceleration may be accessed via pins 2083; or analog signal Z acceleration may be accessed via pins 2084). Alternatively, or in addition, the various values may be routed to the computational functionality (e.g., MCU/ADC conversion 2090) for wireless transmission (e.g., using one or more protocols, such as serial peripheral interface (SPI) protocol 2091) via RF inertial data receiver/transceiver 2092. Further, the protocol, such as the SPI protocol 2091, may be controlled in one of several ways, such as via pins 2086.

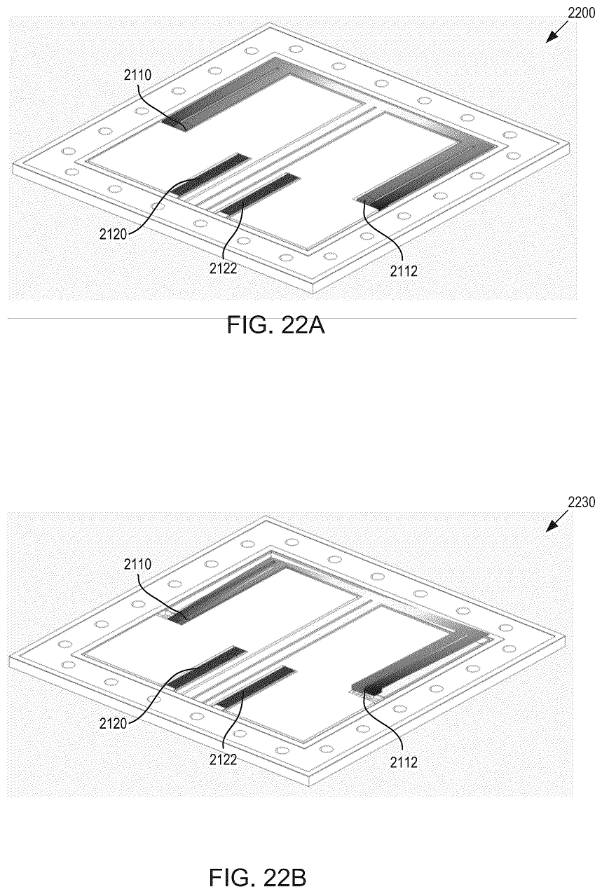

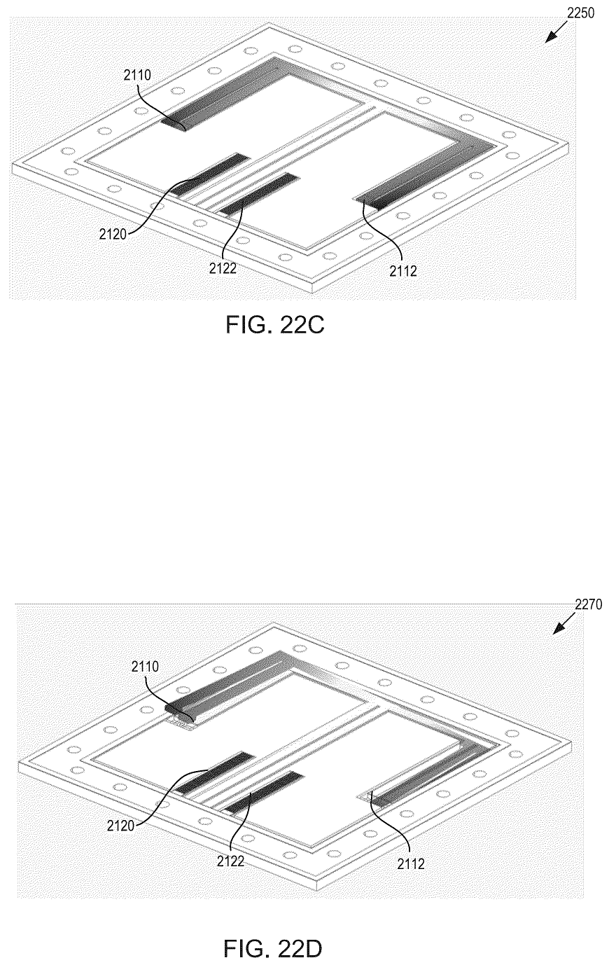

As discussed above, one or both of the gyroscope or the accelerometer may have its mechanical elements (e.g., the elements subject to movement) in a single plane. In one or some embodiments, the mechanical elements may move in that single plane. Alternatively, or in addition, the mechanical elements may move outside of that single plane. See FIGS. 22A-D. Further, as discussed above, in one embodiment, the mechanical elements of both the gyroscope and the accelerometer may be in a single plane. Alternatively, or in addition, the mechanical elements of the gyroscope and the accelerometer may be in different planes. In this regard, one or both of the gyroscope or the accelerometer may be flexibly configured.

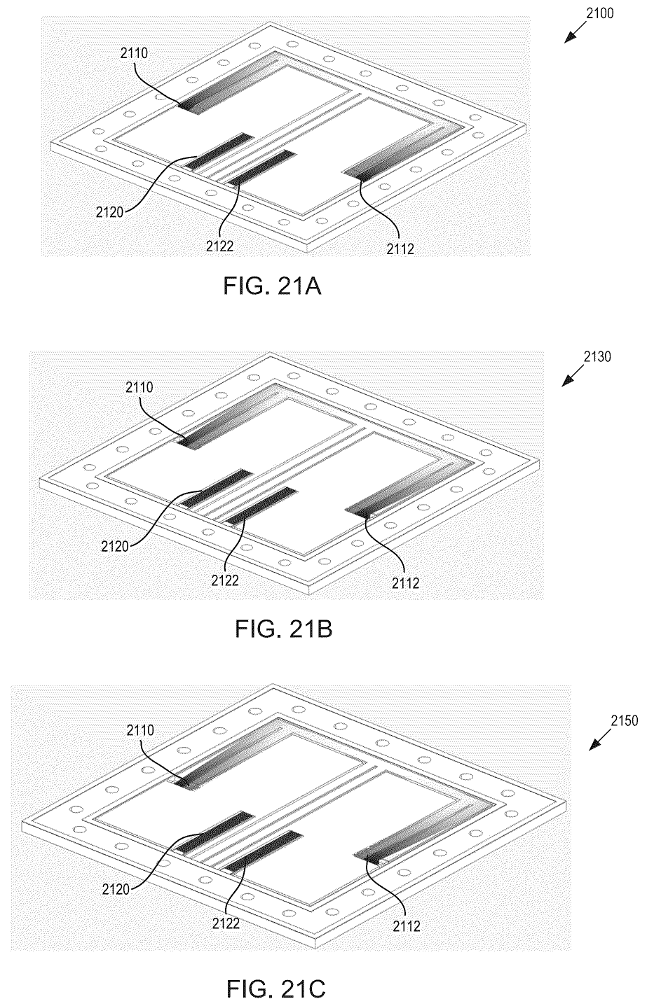

FIGS. 21A-C are illustrations 2100, 2130, 2150 of the gyroscope with in-plane resonators. As discussed above, various function generators may drive gyros, such as in x and y (see sine function generator f_{g} 2012). FIGS. 21A-C illustrate the effects on the arms 2110, 2112, such as complementary movement illustrated at the ends of the arms 2110, 2112.

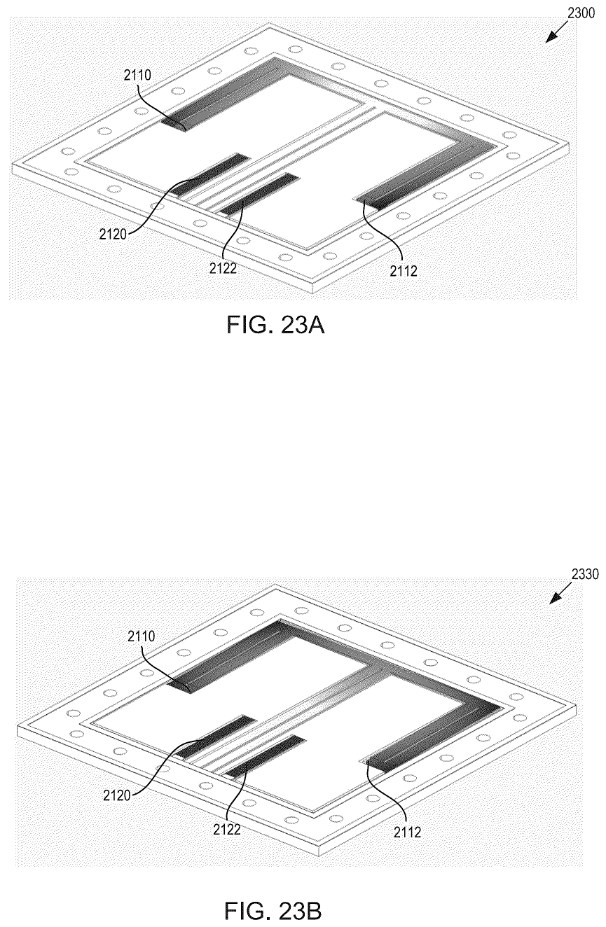

FIGS. 22A-D are illustrations 2200, 2230, 2250, 2270 of the gyroscope with out-of-plane Coriolis vibrations (e.g., rotations around the X/Y axes). As such, FIGS. 22A-D illustrate the effects on the arms 2110, 2112, such as complementary out-of-plane movement illustrated at the ends of the arms 2110, 2112. Likewise, FIGS. 23A-B are illustrations 2300, 2330 of the gyroscope with in-plane Coriolis vibrations (e.g., rotation around the Z axis), as highlighted by the in-plane movement illustrated at the ends of the arms 2110, 2112.

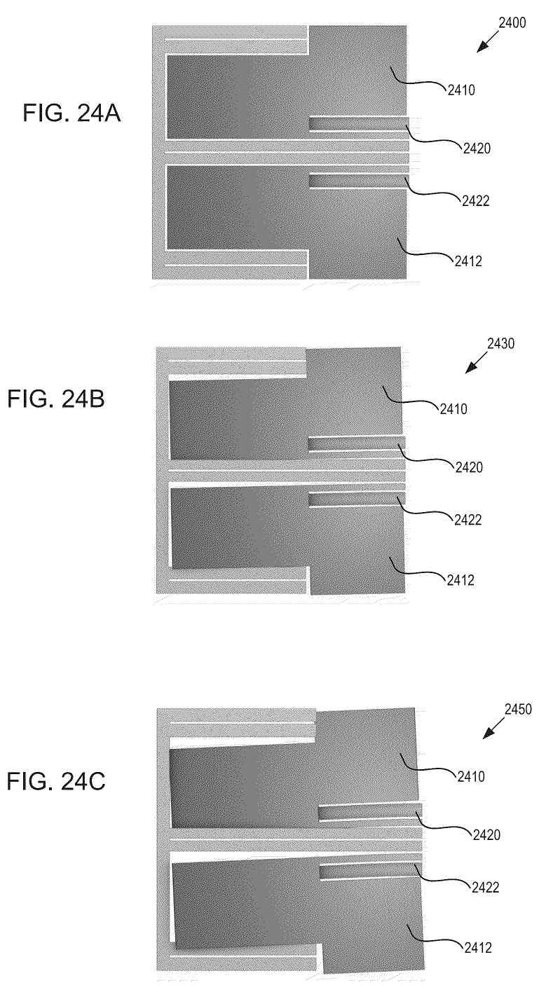

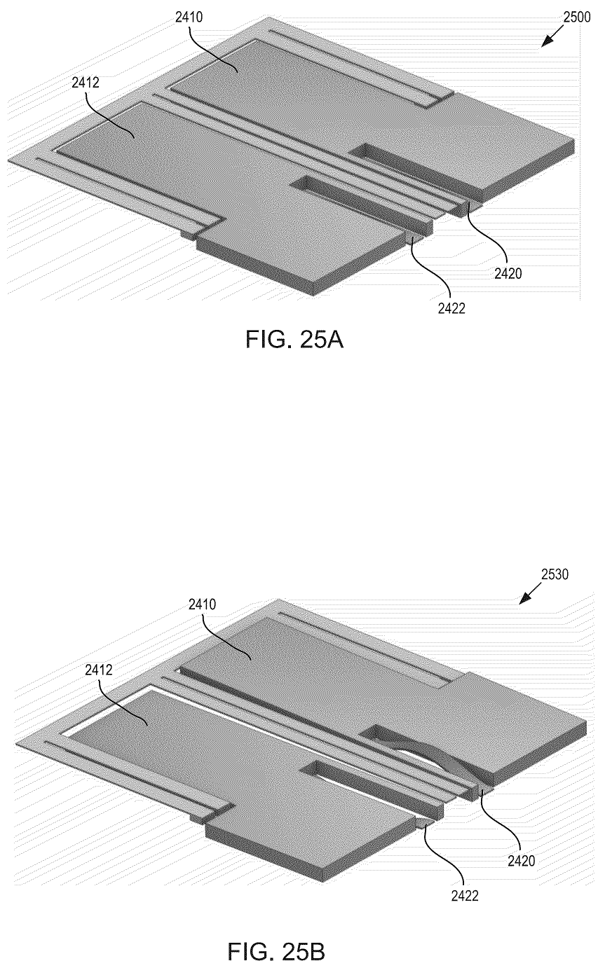

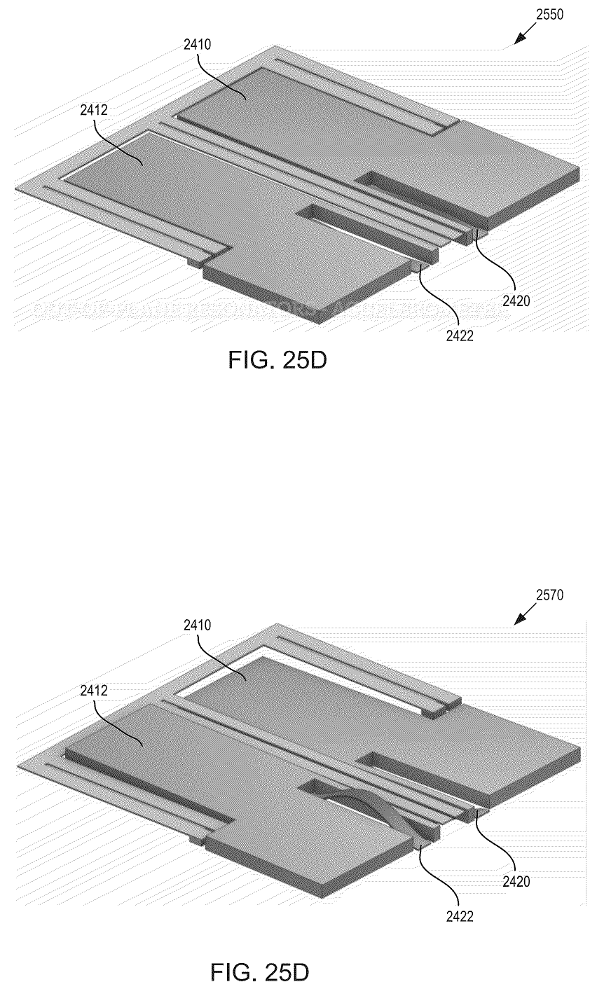

FIGS. 24A-C are illustrations 2400, 24030, 2450 of the accelerometer indicative of acceleration along the Y axis. As discussed above, various functions may drive elements of the accelerometer (see, for example, sine function generator fₓ₁ 2017, sine function generator fₓ₂ 2018, sine function generator f_{y1} 2019, sine function generator f_{y2} 2020). In turn, various elements, such as 2410, 2412, may move in response, such as illustrated in FIGS. 24A-C, which is indicative of acceleration along the Y-axis. Similarly, FIGS. 25A-D are illustrations 2500, 2530, 2550, 2570 of the accelerometer illustrating output-of-plane resonators.

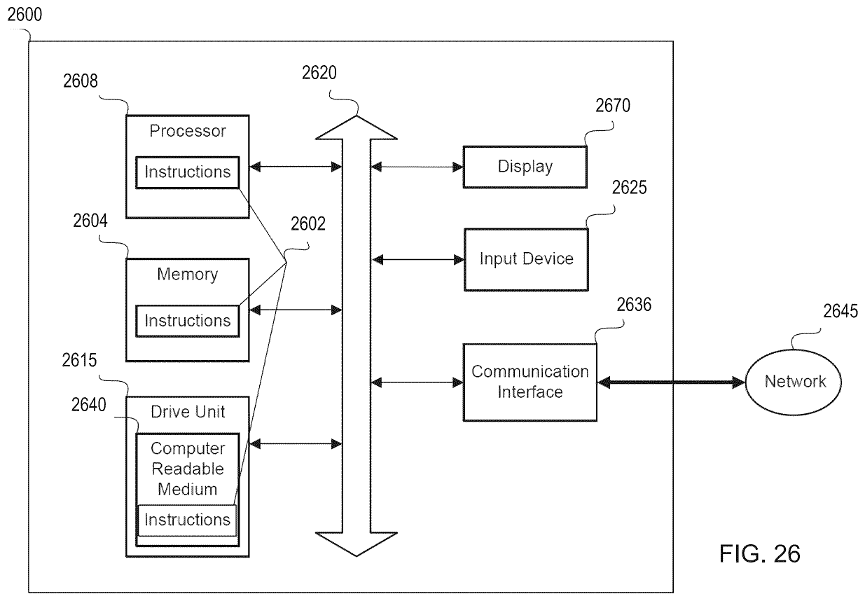

In all practical applications, the present technological advancement is used in conjunction with a computer or other type of computing functionality. The computer or computing functionality may be programmed in accordance with the disclosures herein. As discussed above, the system may comprise an at least partly automated system, such as a fully automated system. As such, in one or some embodiments, computer functionality may be configured as the automated system. One example of computer functionality is disclosed in FIG. 26, which is a general computer system 2600, programmable to be a specific computer system, which may represent any of the computing devices referenced herein, such as the IMU sensor system 100, the electronic device 160, local system/relay 175, or the backend server 180. The computer system 2600 may include an ordered listing of a set of instructions 2602 that may be executed to cause the computer system 2600 to perform any one or more of the methods or computer-based functions disclosed herein. The computer system 2600 can operate as a stand-alone device or can be connected, e.g., using the network 2645, to other computer systems or peripheral devices.

In a networked deployment, the computer system 2600 can operate in the capacity of a server or as a client-user computer in a server-client user network environment, or as a peer computer system in a peer-to-peer (or distributed) network environment. The computer system 2600 can also be implemented as or incorporated into various devices, such as a personal computer or a mobile computing device capable of executing a set of instructions 2602 that specify actions to be taken by that machine, including and not limited to, accessing the Internet or Web through any form of browser. Further, each of the systems described can include any collection of sub-systems that individually or jointly execute a set, or multiple sets, of instructions to perform one or more computer functions.

The computer system 2600 can include a memory 2604 on a bus 2620 for communicating information. Code operable to cause the computer system to perform any of the acts or operations described herein can be stored in the memory 2604. The memory 2604 can be a random-access memory, read-only memory, programmable memory, hard disk drive or any other type of volatile or non-volatile memory or storage device.

The computer system 2600 can include a processor 2608, such as a central processing unit (CPU) and/or a graphics processing unit (GPU). In one implementation, one example of a processor is a controller. Further, one example of a controller is a microcontroller. The processor 2608 can include one or more general processors, digital signal processors, application specific integrated circuits, field programmable gate arrays, digital circuits, optical circuits, analog circuits, combinations thereof, or other now known or later-developed devices for analyzing and processing data. The processor 2608 can implement the set of instructions 2602 or other software program, such as manually programmed or computer-generated code for implementing logical functions. The logical function or any system element described can, among other functions, process and convert an analog data source such as an analog electrical, audio, or video signal, or a combination thereof, to a digital data source for audio-visual purposes or other digital processing purposes such as for compatibility for computer processing.

The computer system 2600 can also include a disk or optical drive unit 2615. The disk drive unit 2615 can include a computer-readable medium 2640 in which one or more sets of instructions 2602, e.g., software, can be embedded. Further, the instructions 2602 can perform one or more of the operations as described herein. The instructions 2602 can reside completely, or at least partially, within the memory 2604 or within the processor 2608 during execution by the computer system 2600.

The memory 2604 and the processor 2608 also can include computer-readable media as discussed above. A “computer-readable medium,” “computer-readable storage medium,” “machine readable medium,” “propagated-signal medium,” or “signal-bearing medium” can include any device that has, stores, communicates, propagates, or transports software for use by or in connection with an instruction executable system, apparatus, or device. The machine-readable medium can selectively be, but not limited to, an electronic, magnetic, optical, electromagnetic, infrared, or semiconductor system, apparatus, device, or propagation medium.

Additionally, the computer system 2600 can include an input device 2625, such as a keyboard or mouse, configured for a user to interact with any of the components of system 2600. It can further include a display 2670, such as a liquid crystal display (LCD), a cathode ray tube (CRT), or any other display suitable for conveying information. The display 2670 can act as an interface for the user to see the functioning of the processor 2608, or specifically as an interface with the software stored in the memory 2604 or the drive unit 2615. For example, the system may include an intuitive user-friendly interface on display 2670 that assists the operator.

The computer system 2600 can include a communication interface 2636 that enables communications via the communications network 2645. The network 2645 can include wired networks, wireless networks, or combinations thereof. The communication interface 2636 network can enable communications via any number of communication standards, such as 802.11, 802.17, 802.20, WiMAX, 802.15.4, cellular telephone standards, or other communication standards, as discussed above. Simply because one of these standards is listed does not mean any one is preferred, as any number of these standards can never actually be adopted in a commercial product.

Block diagrams of different aspects of the system, including FIGS. 1A-C or 20, may be implemented using the computer functionality disclosed in FIG. 26. The present disclosure contemplates a computer-readable medium that includes instructions or receives and executes instructions responsive to a propagated signal, so that a device connected to a network can communicate voice, video, audio, images or any other data over the network. Further, the instructions can be transmitted or received over the network via a communication interface. The communication interface can be a part of the processor or can be a separate component. The communication interface can be created in software or can be a physical connection in hardware. The communication interface can be configured to connect with a network, external media, the display, or any other components in system, or combinations thereof. The connection with the network can be a physical connection, such as a wired Ethernet connection or can be established wirelessly as discussed below. In the case of a service provider server, the service provider server can communicate with users through the communication interface.

The computer-readable medium can be a single medium, or the computer-readable medium can be a single medium or multiple media, such as a centralized or distributed database, or associated caches and servers that store one or more sets of instructions. The term “computer-readable medium” can also include any medium that can be capable of storing, encoding or carrying a set of instructions for execution by a processor or that can cause a computer system to perform any one or more of the methods or operations disclosed herein.

The computer-readable medium can include a solid-state memory such as a memory card or other package that houses one or more non-volatile read-only memories. The computer-readable medium also can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an email or other self-contained information archive or set of archives can be considered a distribution medium that can be a tangible storage medium. The computer-readable medium is preferably a tangible storage medium. Accordingly, the disclosure can be considered to include any one or more of a computer-readable medium or a distribution medium and other equivalents and successor media, in which data or instructions can be stored.

Alternatively, or in addition, dedicated hardware implementations, such as application specific integrated circuits, programmable logic arrays and other hardware devices, can be constructed to implement one or more of the methods described herein. Applications that can include the apparatus and systems of various embodiments can broadly include a variety of electronic and computer systems. One or more embodiments described herein can implement functions using two or more specific interconnected hardware modules or devices with related control and data signals that can be communicated between and through the modules, or as portions of an application-specific integrated circuit. Accordingly, the present system can encompass software, firmware, and hardware implementations.

The methods described herein may be implemented by software programs executable by a computer system. Further, implementations may include distributed processing, component/object distributed processing, and parallel processing. Alternatively, or in addition, virtual computer system processing may be constructed to implement one or more of the methods or functionality as described herein.

Although components and functions are described that may be implemented in particular embodiments with reference to particular standards and protocols, the components and functions are not limited to such standards and protocols. For example, standards for Internet and other packet switched network transmission (e.g., TCP/IP, UDP/IP, HTML, and HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations described herein are intended to provide a general understanding of the structure of various embodiments. The illustrations are not intended to serve as a complete description of all of the elements and features of apparatus, processors, and systems that utilize the structures or methods described herein. Many other embodiments can be apparent to those of skill in the art upon reviewing the disclosure. Other embodiments can be utilized and derived from the disclosure, such that structural and logical substitutions and changes can be made without departing from the scope of the disclosure. Additionally, the illustrations are merely representational and cannot be drawn to scale. Certain proportions within the illustrations may be exaggerated, while other proportions may be minimized. Accordingly, the disclosure and the figures are to be regarded as illustrative rather than restrictive.

The above-disclosed subject matter is to be considered illustrative, and not restrictive, and the appended claims are intended to cover all such modifications, enhancements, and other embodiments, which fall within the true spirit and scope of the present disclosure. Thus, to the maximum extent allowed by law, the scope of the present embodiments are to be determined by the broadest permissible interpretation of the following claims and their equivalents, and shall not be restricted or limited by the foregoing detailed description. While various embodiments have been described, it will be apparent to those of ordinary skill in the art that many more embodiments and implementations are possible within the scope of the above detailed description. Accordingly, the embodiments are not to be restricted except in light of the attached claims and their equivalents.

What is claimed is:

1. A micro-structured inertial measurement sensor (IMS) comprising:
a peripheral frame;
one or more mechanical elements supported at least partly by the peripheral frame, wherein the one or more mechanical elements are planar in structure, at least partly piezoelectric, and configured to generate movement indicative of rate of rotation and of acceleration; and
one or more sensing elements configured to generate a plurality of signals indicative of the rate of rotation and of the acceleration.

2. The IMS of claim 1, wherein the one or more mechanical elements comprise one or more suspension arms and are configured to generate movement in three orthogonal axes for each of the rate of rotation and the acceleration; and
wherein the one or more sensing elements are configured to generate the plurality of signals indicative of the rate of rotation and indicative of linear acceleration.

3. The IMS of claim 2, wherein the one or more mechanical elements comprise sputtered piezoelectric material on a surface of the one or more mechanical elements.

4. The IMS of claim 3, wherein the one or more mechanical elements comprise a plurality of monolithic orthogonal structures comprising one or more gyroscopes and one or more accelerometers that are manufactured in combination and that are suspended by the peripheral frame.

5. The IMS of claim 4, wherein the monolithic orthogonal structure comprises an E-shape structure configured as a gyroscope that is suspended by a center arm either to a second E-shape structure configured as an accelerometer or directly to a peripheral frame;
wherein the accelerometer is suspended by a center hinge to the peripheral frame.

6. The IMS of claim 5, wherein the one or more mechanical elements are configured to drive and sense in-plane and out-of-plane movements.

7. The IMS of claim 6, wherein the plurality of monolithic orthogonal structures comprise a first E-shaped monolithic gyroscope-accelerometer that is a mirrored in-plane image at 45° of a second E-shaped monolithic gyroscope-accelerometer.

8. The IMS of claim 3, wherein the one or more mechanical elements comprise a first planar structure gyroscope and a second planar structure accelerometer;
wherein the first planar structure gyroscope is positioned at least partly on a first layer of the IMS; and
wherein the second planar structure accelerometer is positioned at least partly on a second layer of the IMS, the second layer of the IMS being different than the first layer of the IMS.

9. The IMS of claim 3, further comprising at least one processor configured to analyze at least one aspect of frequency for the plurality of signals in order to determine the rate of rotation and the acceleration.

10. The IMS of claim 9, wherein the at least one processor is configured to:
analyze amplitude of the frequency of one or more of the plurality of signals in order to determine the rate of rotation; and
analyze the frequency of other of the plurality of signals in order to determine the acceleration.

11. The IMS of claim 10, wherein the one or more sensing elements comprise analog circuitry configured to:
generate an analog electric signal that is proportional to the amplitude of the frequency of the one or more of the plurality of signals; and
generate an analog electric signal that is proportional to the frequency shift of the other of the plurality of signals;
wherein the at least one processor is configured to analyze the analog electric signal that is proportional to the amplitude of the frequency of the one or more of the plurality of signals in order to determine the rate of rotation; and
wherein the at least one processor is configured to analyze the analog electric signal that is proportional to the frequency shift of the other of the plurality of signals in order to determine the acceleration.

12. The IMS of claim 1, wherein the one or more mechanical elements comprise an accelerometer function that is configured to use one or more drive resonators in a push-pull arrangement along an X or Y axis.

13. The IMS of claim 12, wherein one or more drive resonators comprise a first drive resonator and a second drive resonator are disposed on each side of a center hinge; and
wherein the first drive resonator is configured to input a 180° shifted drive signal compared to that input to the second drive resonator.

14. The IMS of claim 13, wherein, for an axis along X or Y, frequency shift between the first drive resonator and the second drive resonator disposed on each side of a center hinge is proportional to the acceleration along the axis.

15. The IMS of claim 12, wherein the accelerometer function is configured to use the one or more drive resonators in a push-pull arrangement along a Z axis.

16. The IMS of claim 15, wherein a difference between a sum of frequencies from one or more top resonators compared to a sum of frequencies from one or more bottom resonators is proportional to the acceleration along the Z axis.

17. The IMS of claim 1, wherein the one or more mechanical elements comprise a gyroscope function that is configured to use one or more in-plane drive resonators that generate out-of-plane inertial energy for a non-resonant sensing function when a rotation occurs around an X or Y axis.

18. The IMS of claim 17, wherein the gyroscope function is configured to use a plurality of the in-plane drive resonators that generate in-plane inertial energy for a non-resonant sensing function when a rotation occurs around a Z axis.

19. The IMS of claim 1, further comprising one or more non-resonant piezoelectric energy harvester elements in a planar arrangement with the one or more mechanical elements; and
wherein the one or more non-resonant piezoelectric energy harvester elements are configured to convert inertial energy from ambient motion and vibrations of the one or more mechanical elements into electricity.

20. The IMS of claim 1, further comprising one or more non-resonant piezoelectric energy harvester elements in a different plane from the one or more mechanical elements that is outside of a die area housing the one or more mechanical elements but inside a sealed electronic package housing the IMS; and
wherein the one or more non-resonant piezoelectric energy harvester elements are configured to convert inertial energy from ambient motion and vibrations of the one or more mechanical elements into electricity.

21. The IMS of claim 1, further comprising a top cover and a bottom cover at wafer level that sandwiches the one or more mechanical elements; and
wherein the top cover and the bottom cover are vacuum-sealed using two parallel and concurrent eutectic seals.

22. The IMS of claim 21, further comprising a plurality of additional layers between the top cover and the bottom cover packaged at the wafer level and vacuum-sealed using two parallel and concurrent eutectic seals between each of the plurality of additional layers.

23. The IMS of claim 21, further comprising embedded active or passive electronic components comprising one or more of resistors, capacitors, operational amplifiers or microcontroller that are integrated in packaged or die forms on one or more additional layers or directly in a cavity of one or both of the top cover or the bottom cover.
